(19) United States
(12) Patent Application Publication
(10) Pub. No.: US 2017/0067748 A1
(43) Pub. Date: Mar. 9, 2017

(54) Location-Based Search Refinements

(71) Applicant: Quixey, Inc., Mountain View, CA (US)

(72) Inventors: Eric J. Glover, Palo Alto, CA (US); James Delli Santi, San Jose, CA (US)

(73) Assignee: Quixey, Inc., Mountain View, CA (US)

(21) Appl. No.: 14/847,770

(22) Filed: Sep. 8, 2015

(51) Int. Cl. G01C 21/34

(52) U.S. Cl. CPC G01C 21/3476

(57) ABSTRACT

A method includes receiving a search query and one or more context parameters from a user device. The search query indicates a search string. The method includes determining a search area based on at least one of the search string or the one or more context parameters, and obtaining a set of point of interest records based on the search area. The method includes clustering the point of interest records into clusters based at least on locations of the respective points of interest and generating one or more location-based refinements based on the clusters of the of point of interest records. Each location-based refinement is based on one of the clusters of the point of interest records and includes a display portion and a refined search query that is constrained by the refined search area. The method includes transmitting the one or more location-based refinements to the user device.

### TECHNICAL FIELD

This disclosure relates to refining search results based on location based refined search results.

### BACKGROUND

In recent years, use of computers, smartphones, and other Internet-connected devices has grown exponentially. Correspondingly, the number of available software applications for such devices has also grown. Today, many diverse native and web software applications can be accessed on any number of different devices, including, but not limited to, smartphones, personal computers, automobiles, and televisions. These diverse applications can range from business driven applications, games, educational applications, news applications, shopping applications, messaging applications, media streaming applications, social networking applications, and so much more. Furthermore, application developers develop vast amounts of applications within each genre and each application may have numerous editions.

A large number of native and web software applications are dedicated to maps and finding specific locations near a user device executing the native or web software application. For example, the user device can execute a map application that provides a location on a map. Some of these map applications may also provide other features, such as, but not limited to, providing directions to the location or navigating to the location.

### SUMMARY

One aspect of the disclosure provides a method for generating location-based search refinements. The method includes receiving, at data processing hardware, a search query related to a point of interest search on a user device. The method includes determining, by the data processing hardware, a search area based on the search query. The method further includes identifying, by the data processing hardware, points of interest in the search area and generating one or more location-based refinements based on the search query and the identified points of interest in the search area. Each location-based refinement is a modification of the search query that includes a geographical location constraint narrowing the search area. The method also includes transmitting the one or more location-based refinements from the data processing hardware to the user device.

Implementations of the disclosure may include one or more of the following optional features. In some implementations, the method includes determining the search area based on one or more context parameters from the user device. The search query may include a search string. Determining the search area may include parsing the search string to determine whether the search string explicitly defines a known location. When the search string includes a name of a known location, the method includes setting the search area based on the known location. When the search string fails to include the known location, the method includes determining a current location of the user device based on the one or more context parameters and setting the search area based on the current location of the user device. Setting the search area based on the known location may include identifying a geographic coordinate representing the known location and determining a geographic perimeter about the known location. Setting the search area based on the current location of the user device may further include identifying a geographic coordinate representing the current location and determining a geographic perimeter about the geographic coordinate.

In some examples, identifying the points of interest in the search area may include obtaining, by the data processing hardware, a set of point of interest records based on the search area. Each point of interest record may identify a point of interest, a location of the point of interest, and one or more features of the point of interest. The method may also include clustering, by the data processing hardware, the point of interest records into clusters based at least on the locations of the respective points of interest and generating, by the data processing hardware, the one or more location-based refinements based on the clusters of the point of interest records. Each location-based refinements may be based on one of the clusters of the point of interest records and include: i) a display portion indicating an entity and a refined search area corresponding to one or more points of interest defined in the cluster; and ii) a refined search query constrained by the refined search area. The one or more features of each point of interest record may include classification data indicating one or more categories of the point of interest. The point of interest records may be clustered based on the respective locations identified in the point of interest records and the classification data defined in the point of interest records.

In some examples, the method includes receiving, at the data processing hardware, one of the refined search queries from the user device in response to a user selection of a respective location-based refinement. The method may also include generating, by the data processing hardware, search results based on the received refined search query and the refined search area, and transmitting, by the data processing hardware, the search results to the user device. Each search result may include a header for an application executable by the user device and one or more application access mechanisms associated with the application and the search area. Each application access mechanism may have a reference to the application and indicate a performable operation for the application, the performable operation associated with the search area.

Another aspect of the disclosure provides a second method for generating location-based search refinements. The method includes receiving, at data processing hardware, a search query and one or more context parameters from a user device, the search query indicating a search string. The method also includes determining, by the data processing hardware, a search are based on at least one of the search string or the one or more context parameters, and obtaining, by the data processing hardware, a set of point of interest records based on the search area. Each point of interest record identifies a point of interest, a location of the point of interest, and one or more features of the point of interest. The method further includes clustering, by the data processing hardware, the point of interest records into clusters based at least on the locations of the respective points of interest and generating, using the data processing hardware, one or more location-based refinements based on the clusters of the point of interest records. Each location-based refinement is based on one of the clusters of the point of interest records and includes: i) a display portion indicating an entity and a refined search area corresponding to one or more points of interest defined in the cluster; and ii) a refined search query constrained by the refined search area. The method also includes transmitting, by the data processing hardware, the one or more location-based refinements to the user device.

This aspect may include one or more of the following optional features. In some examples, the method includes receiving, at the data processing hardware, one of the refined search queries from the user device in response to a user selection of a respective location-based refinement. The method may also include generating, by the data processing hardware, search results based on the received refined search query and the refined search area, and transmitting, by the data processing hardware, the search results to the user device. Each search result may include a header for an application executable by the user device and one or more application access mechanisms associated with the application and the search area. Each application access mechanism may have a reference to the application and indicate a performable operation for the application, the performable operation associated with the search area. Each search area may include parsing the search string to determine whether the search string explicitly defines a known location. When the search string includes a name of a known location, the method includes setting the search area based on the known location. When the search string fails to include the known location, the method includes determining a current location of the user device based on the one or more context parameters and setting the search area based on the current location of the user device.

Setting the search area based on the known location may include identifying a geographic coordinate representing the known location and determining a geographic perimeter about the known location. Setting the search area based on the current location of the user device may include identifying a geographic coordinate representing the current location and determining a geographic perimeter about the geographic coordinate.

In some examples, the one or more features of each point of interest record include classification data indicating one or more categories of the point of interest. The point of interest records may be clustered based on the respective locations identified in the point of interest records and the classification data defined in the point of interest records. Generating the one or more location-based refinements may include, for each cluster, determining a representative point of interest of the cluster and scoring each cluster based on one or more features of the cluster and one or more features of the representative point of interest. The method may further include selecting one or more of the clusters based on the scores thereof. For each selected cluster the method may include determining the entity to use in the display portion based on the point of interest records of the selected cluster, determining the refined search area based on the locations defined in the point of interest records of the selected cluster, the refined search area containing each of the locations, and determining the refined search query based on the entity and the search area.

The entity to use in the display portion may be based on classification data of the point of interest records contained in the selected cluster, the classification data of each point of interest record defining one or more categories of the point of interest defined in the point of interest record. The refined search area indicated in the display portion may be based on a name of the representative point of interest. The representative point of interest of a particular cluster may be one of a generally known point of interest, a user-specific point of interest, or an arbitrary point of interest.

Determining the representative point of interest may include determining whether the cluster includes a user-specific point of interest related specifically to a user of the user device. When the cluster includes the user-specific point of interest or a generally known point of interest, the method may include setting the representative point of interest to the user specific point of interest. When the cluster does not include the user-specific point of interest, the method may include determining whether the cluster includes a generally known point of interest having at least a threshold popularity amongst a general population. When the cluster includes the generally known point of interest, the method may include setting the representative point of interest to the generally known point of interest. When the cluster does not include the user-specific point of interest, the method includes selecting an arbitrary point of interest within the cluster and setting the representative point of interest to the arbitrary point of interest. Each entity may include a location, a business name, a business type, a product name, a product type, a service provider name, a service type, or a destination.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a schematic view of an example environment including a user device in communication with a search system having a search module and a refinement module.

FIG. 1B is a functional block diagram of a search system interacting with user devices and data sources.

FIGS. 2A and 2B are schematic views of an example user device in communication with a search system.

FIG. 3 is a functional block diagram of a search system.

FIGS. 4A and 4B are schematic views of n example application state records.

FIGS. 5A and 5B are schematic views of example point of interest records.

FIGS. 6A and 6B are schematic views of example entity records.

FIG. 7 is a functional block diagram of a search module receiving a search query and outputting search results.

FIG. 8 is a schematic view illustrating a location area with clustered points of interest.

FIG. 9 is a schematic view illustrating an example method for generating auto-suggest search results on a search system.

FIG. 10 is a schematic view illustrating an example method for transmitting location based refinements to a user device.

FIG. 11 is a schematic view illustrating an example method for generating location-based refinements.

FIG. 12 is a schematic view illustrating an example method for generating location-based refinement associated with point of interest clusters.

FIG. 13 is a schematic view illustrating an example method for generating location-based refinement associated with point of interest clusters.

FIG. 14 is a schematic view illustrating an example method for generating and transmitting location-based refinements based on a search query and identified points of interest in a search area.

FIG. 15 is a schematic view of an example computing device executing any systems or methods described herein.

Like reference symbols in the various drawings indicate like elements.

### DETAILED DESCRIPTION

A system of the present disclosure implements a search based on a query received from a user device (e.g., a mobile device). The query may include a search string and a search location, such as a location of the user device, a point of interest, or a location of interest. The system may determine a search area based on the search location and execute a first search of one or more data sources (e.g., including a point of interest database or an application state database) to determine points of interest and/or organic search results. Each point of interest is associated with a location within the search area and sometimes also adjacent to the search area. The system groups the points of interest into clusters based on the locations of the points of interest and generates a location-based refinement for each cluster, where each location-based refinement includes at least a portion of the search string. Additionally or alternatively, the system may group the points of interest into clusters based on other qualities. The system transmits the location-based refinements to the user device. The user device displays the location-based refinements and allows the user to select one. In response to receiving a selection of one of the location-based refinements, the system executes a second search of the one or more data sources (e.g., including a point of interest database or an application state database) using the selected location-based refinement, resulting in refined search results. The user device receives the location-based search results and renders at least some of them on a user display of the user device.

The organic results and the location-based search results include various mechanisms for accessing applications (e.g., allowing the user to find a restaurant) relevant to the query of the user. In response to a user selection of an application access mechanism, the user device may launch an application referenced in the application access mechanism and perform the one or more operations indicated in the application access mechanism. A cluster may be defined based on the density of points of interest within a certain area. For example, a cluster of points of interest within a city may reside within a smaller area than a cluster of points of interest located in the suburbs of the city.

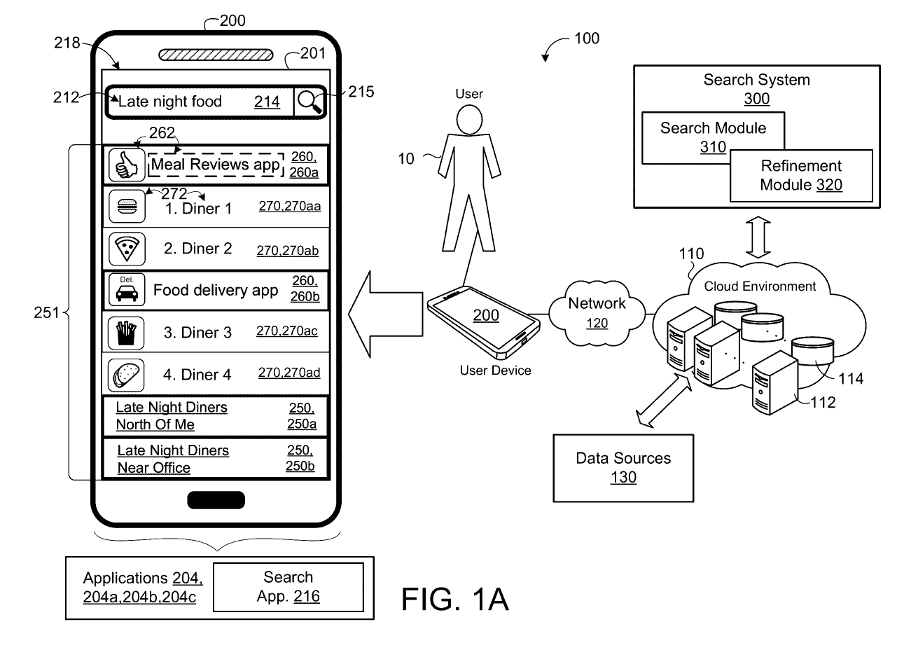

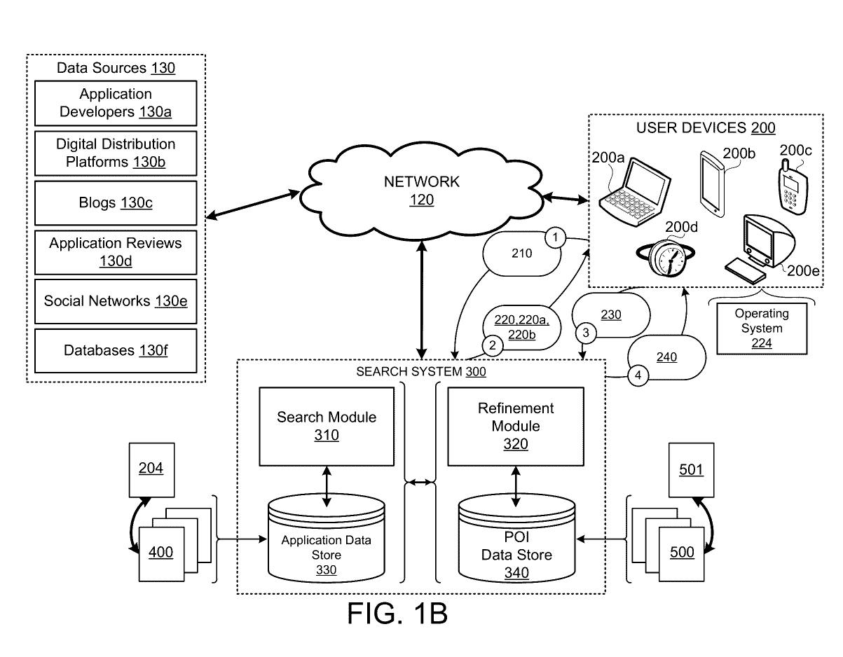

FIG. 1A illustrates an example system 100 that includes a user device 200 associated with a user 10 in communication with a remote system 110 via a network 120. The remote system 110 may be a distributed system (e.g., cloud environment) having scalable/elastic computing resources 112 and/or storage resources 114. The user device 200 and/or the remote system 110 may execute a search system 300 having a search module 310 and a refinement module 320 and optionally receive data from one or more data sources 130. In some examples, the refinement module 320 is part of the search module 310. In other examples, the search module 310 and the refinement module 320 communicate with each other and with one or more user devices 200 and the data source(s) 130 via the network 120. The network 120 may include various types of networks, such as a local area network (LAN), wide area network (WAN), and/or the Internet.

FIG. 1B shows an example user device 200 in communication with the search system 300. User devices 200 can be any computing devices that are capable of providing search queries 212 to the search system 300. User devices 200 include, but are not limited to, mobile computing devices, such as laptops 200a, tablets 200b, smart phones 200c, and wearable computing devices 200d (e.g., headsets and/or watches). User devices 200 may also include other computing devices having other form factors, such as computing devices included in desktop computers 200e, vehicles, gaming devices, televisions, or other appliances (e.g., networked home automation devices and home appliances).

The user devices 200 may use a variety of different operating systems 224. In examples where the user device 200 is a mobile device, the user device 200 may run an operating system including, but not limited to, ANDROID® developed by Google Inc., IOS® developed by Apple Inc., or WINDOWS PHONE® developed by Microsoft Corporation. Accordingly, the operating system 224 running on the user device 200 may include, but is not limited to, one of ANDROID®, IOS®, or WINDOWS PHONE®. In an example where the user device 200 is a laptop 200a or desktop computing device 200e, the user device 200 may run an operating system 224 including, but not limited to, MICROSOFT WINDOWS® by Microsoft Corporation, MAC OS® by Apple, Inc., or Linux. User devices 200 may also access the search system 300 while running operating systems 224 other than those operating systems 224 described above, whether presently available or developed in the future.

Referring back to FIGS. 1A and 1B, the search system 300 receives a search query 212 from the user device 200 and performs a first search within its respective storage systems (i.e., application data store 330 and Point of Interest (POI) data store 340). In some examples, it is desirable that the first search includes search results 220 having one or more location-based refinements 220b based on the search query 212. A displayed location-based refinement 250 provides the user 10 with a link that re-queries or performs a second search of the search system 300 with a refined or more specific search query based on the location-based refinement 220b. When the user 10 selects a displayed location-based refinement 250 on the user device (i.e., a location-based refinement 220b), the search system 300 executes the second search and returns refined search results 240. As shown in FIG. 1A, a user 10 looking for late night diners, enters “late night diners” (i.e., the search query 212) in a search box 214 of a graphical user interface (GUI) 218. The search system 300 executes a first search and displays a list 251 of search results 220 transmitted from the search system 300. The displayed search results 250, 260, 270 include displayed organic search results 260, 270 and displayed location-based refinement 250 (based on the location-based refinement 220b). Each displayed location-based refinement 250 includes a user-selectable link that when selected re-queries the search system 300 with a refined search query 221. The refined search query 221 partially disambiguates the intent of the search query 212 or otherwise narrows the intent of the search query 212. A location-based refinement 220b is a refinement that corresponds to a geographic point or area. For example, a user 10 at work may enter a search query 212 for “late night diners.” The search system may generate the organic displayed results 260, 270 and displayed location-based refinement 250. The displayed location-based refinement 250 that may be displayed in the result list 251 may include: “late night diners by me,” “late night diners near work,” “late night diners off of I-280.” or “late night diners near Golden Gate Park.” When the user 10 selects one of the displayed location-based refinements 250, the user 10 helps the search system 300 understand where to narrow or focus its search.

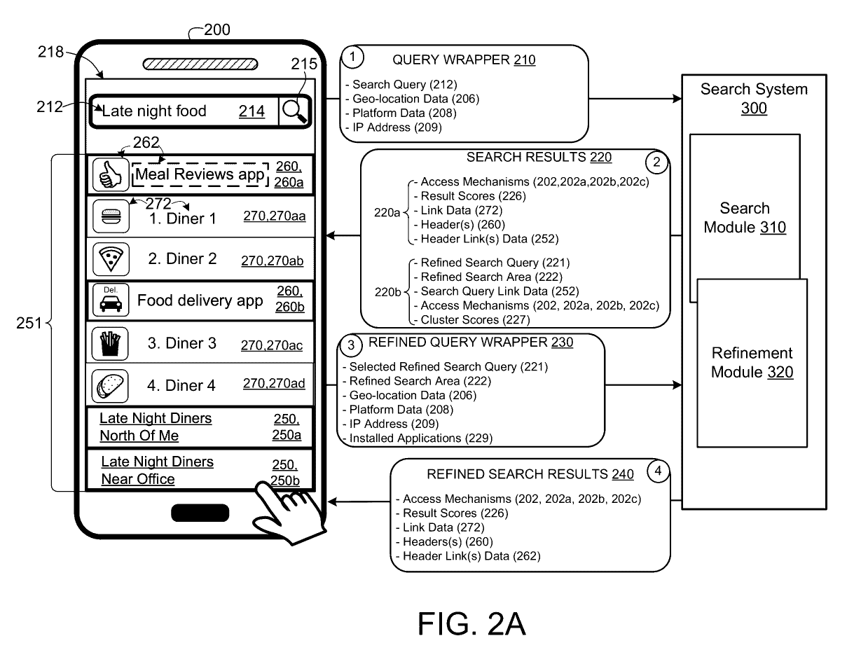

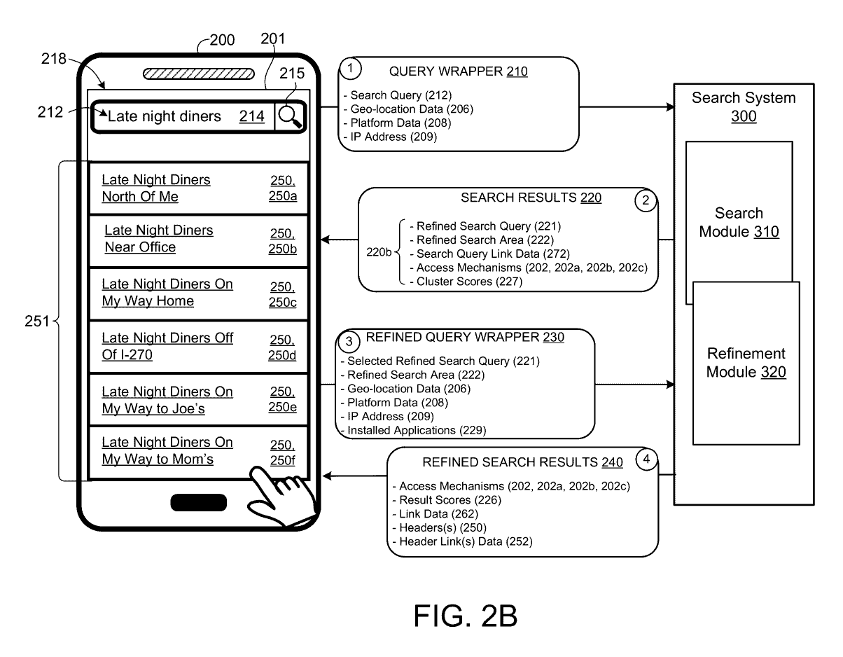

To provide the location-based refinements 220b (e.g., the displayed location-based refinements 250), the search system 300 leverages the search query 212 or query wrapper 210 (FIGS. 2A-2C) (e.g., search query 212 as well as geo-location data 206 and/or IP address 209) to determine a search location (e.g., a geo-fence) for narrowing the search results 220. As shown in FIG. 1A, some of the example displayed location-based refinements 250 include, but are not limited to, “north of me”, “near office”, “on my way home”, “off of I-280”, “on my way to Joe's/Mom's” or any other user specified location, or system generated location. Each displayed location-based refinement 250 is a search result 220 of a first search of the search system 300 in response to the search query 212.

The system 100 is described with respect to a search system 300 that executes a first search when the user enters text into a search box 214 and a second search when the user 10 selects the displayed location-based refinement 250. However, in some implementations, the system 100 executes the first and second searches in response to a trigger received from the user device 200. A trigger may include, but is not limited to, a voice command input by the user 10, a selection of a specific icon of the GUI 218, or an order selection of one or more links displayed on the GUI 218. For example, the user 10 may say “Chinese food,” triggering the system 100 to execute the first and second searches. In other examples, the user 10 says “Chinese food near my house,” which triggers the system to execute the second search for POIs 501 near the user's house.

In some examples, the user 10 selects a search button 215, after entering a search query 212 in the search text box 214, which triggers the search system 300 to execute the search. While in other examples, the system executes an incremental search, e.g., an incremental search query 212. Incremental search queries 212 refer to search queries 212 that are updated each time the user 10 enters a new character in the search box 214. For example, if the user 10 intends to enter the query term “earthquake,” the user 10 may enter the progression e-a-r-t-h-q-u-a-k-e. In this example, the incremental search queries 212 include {“e,” “ea,” “ear,” “eart” “earth,” “earthq.” “earthqu,” “earthqua,” “earthquak,” and “earthquake,” }. The search system 300 or the search application 216 (on the user device 200) monitors each character entry and determines a set of possible query strings, as well as a probability that the possible query string is the intended string. Drawing from the example above, when the user 10 enters “ear” the query strings “ear” “earth” and “earthquake” are probably going to have higher probability strings than “earwig” or “earwax.” The search system 300 or the search application 216 may utilize a TRIE to generate the possible query strings. TRIE, also known as a digital tree, radix tree, or prefix tree, is an ordered tree data structure used to store a dynamic set or associative array. The keys in a TRIE are usually a string. Other methods for generating query strings are possible as well. In other implementations, the incremental search query 212 is only the partial query string entered by the user 10. In these implementations, the search system 300 is queried with the partial query string using a “begins with [string]” command or a “includes [command]” command.

In some implementations, the user device 200 executes one or more software applications 204, such as, but not limited to, a search software application 216. A software application 204 may refer to computer software that, when executed by a computing device, causes the computing device to perform a task. In some examples, a software application 204 is referred to as an “application”, an “app”, or a “program”. Example software applications 204 include, but are not limited to, word processing applications, spreadsheet applications, messaging applications, media streaming applications, social networking applications, and games.

Applications 204 may be executed on a variety of different user devices 200. In some examples, a native application 204a is installed on the user device 200 prior to the user 10 purchasing the user device 200. In other examples, the user may 10 download and install native applications 204a on the user device 200.

The functionality of an application 204 may be accessed on the user device 200 on which the application 204 is installed. Additionally or alternatively, the functionality of the application 204 may be accessed via a remote computing device 112. In some examples, all of an application's functionality is included on the user device 200 on which the application 204 is installed. These applications 204 may function without communication with other computing devices 112 or other user devices (e.g., via the Internet). In other examples, an application 204 installed on the user device 200 may access information from other remote computing devices 112 during operation. For example, a weather application installed on a computing device 200 may access the latest weather information via the Internet and display the accessed weather information to the user 10 through the installed weather application. In still other examples, a web-based application 204b (also referred to herein as a web application) may be partially executed by the user's computing device 200 and partially executed by a remote computing device 112. For example, a web application 204b may be an application 204 that is executed, at least in part, by a web server and accessed by a web browser (e.g., a native application 204a) of the user device 200. Example web applications 204b may include, but are not limited to, web-based email, online auctions, and online retail sites.

In general, the user device 200 may communicate with the search system 300 using any software application 204 that may transmit search queries 212 to the search system 300. In some examples, the user device 200 runs a native application 204a dedicated to interfacing with the search system 300, such as a native application 204a dedicated to searches (e.g., a search application 216). In some examples, the user device 200 communicates with the search system 300 using a more general application 204, such as a web-browser application 204b accessed using a web browser native application 204a. Although the user device 200 may communicate with the search system 300 using the native search application 216 and/or a web-browser application 204b, the user device 200 may be described hereinafter as using the native search application 216 to communicate with the search system 300. In some implementations, the functionality attributed to the search application 216 is included as a searching component of a larger application 204 that has additional functionality. For example, the functionality attributed to the search application 216 may be included as part of a native application 204a or a web application 204b as a feature that provides search capabilities.

Native applications 204a may perform a variety of different functions for the user 10. For example, a restaurant reservation application makes reservations for restaurants. As another example, an internet media player application streams media (e.g., a song or movie) from the Internet. In some examples, a single native application 204a performs more than one function. For example, a restaurant reservation application may also allow the user 10 to retrieve information about a restaurant and read user reviews for the restaurant in addition to making reservations. As another example, an internet media player application may also allow the user 10 to perform searches for digital media, purchase digital media, and generate media playlists.

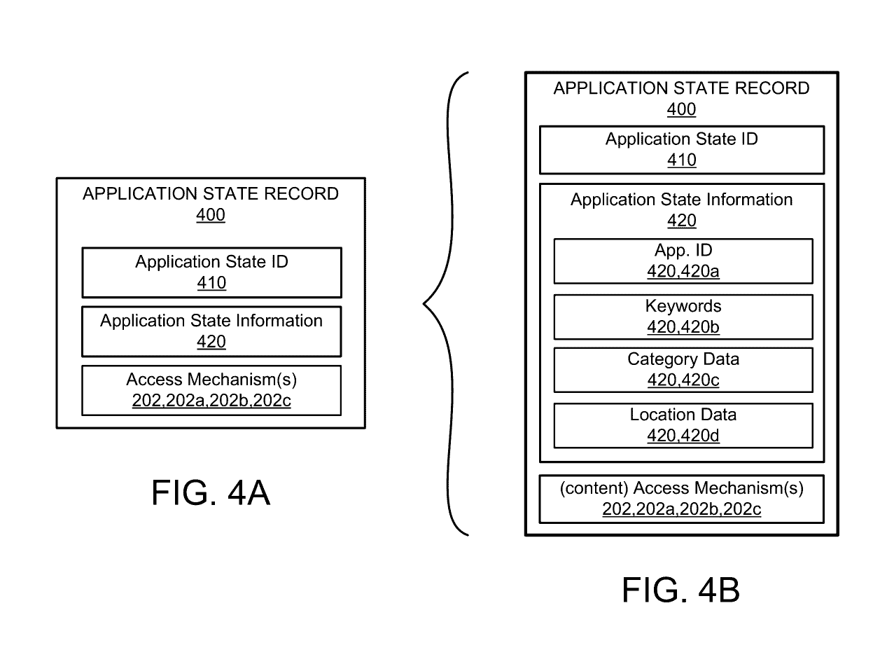

Referring back to FIGS. 1A and 1B, the search system 300 includes a search module 310, a refinement module 320, in communication with an application data store 330 and a point of interest (POI) data store 340. The application data store 330 stores one or more application state records (FIGS. 4A and 4B), while the POI data store 340 stores POI records 500 associated with a POI 501. The application data store 330 and/or the POI data store 340 may include one or more databases, indices (e.g., inverted indices), tables, files, or other data structures, which may be used to implement the techniques of the present disclosure.

The data sources 130 may include a variety of different data providers. The data sources 130 may include data from application developers 130a, such as application developers' websites and data feeds provided by developers. The data sources 130 may include operators of digital distribution platforms 130b configured to distribute native applications 204a to user devices 200. Example digital distribution platforms 130b include, but are not limited to, the GOOGLE PLAY® digital distribution platform by Google, Inc., the APP STORE® digital distribution platform by Apple, Inc., and WINDOWS PHONE® Store developed by Microsoft Corporation.

The data sources 130 may also include other websites, such as websites that include web logs 130c (i.e., blogs), application review websites 130d, or other websites including data related to applications 204. Additionally, the data sources 130 may include social networking sites 130e, such as “FACEBOOK®” by Facebook, Inc. (e.g., Facebook posts) and “TWITTER®” by Twitter Inc. (e.g., text from tweets). Data sources 130 may also include online databases 130f that include, but are not limited to, data related to movies, television programs, music, and restaurants. Data sources 130 may also include additional types of data sources in addition to the data sources 130 described above. Different data sources 130 may have their own content and update rate.

The search system 300 retrieves data from one or more of the data sources 130. The data retrieved from the data sources 130 may include any type of data related to application functionality and/or application states. The search system 300 generates application state records 400 based on the data retrieved from the data sources 130. In some examples, a human operator manually generates some data included in the application state records 400. The search system 300 may update data included in the application state records 400 over time so that the search system 300 provides up-to-date search results 220, 240.

Referring to FIGS. 1A-2B, in some implementations, the search system 300 executes the first search based on a received query wrapper 210. The query wrapper 210 includes the search query 212. The query wrapper 210 may include additional data along with the search query 212. For example, the query wrapper 210 may include device location data 206 (e.g., geo-location) that indicates the location of the user device 200, such as latitude and longitude coordinates. The user device 200 may include a global positioning system (GPS) receiver that generates the geo-location data 206 transmitted in the query wrapper 210. The query wrapper 210 may also include an IP address 209, which the search module 310 may use to determine the location of the user device 200. In some examples, the query wrapper 210 also includes additional data, including, but not limited to, platform data 208 (e.g., version of the operating system 224, device type, and web-browser version), an identity of the user 10 of the user device 200 (e.g., a username), partner specific data, and other data.

The search system 300 receives the query wrapper 210 and generates search results 220 based on the data stored in the application data store 330 and/or the POI data store 340, and optionally the entity data store 350. In some implementations, the search module 310 receives the query wrapper 210 from the user device 200 and performs a search for application state records 400 to determine the organic search results 220a and a search of the POI data store 340 to determine the location-based refinements 220b.

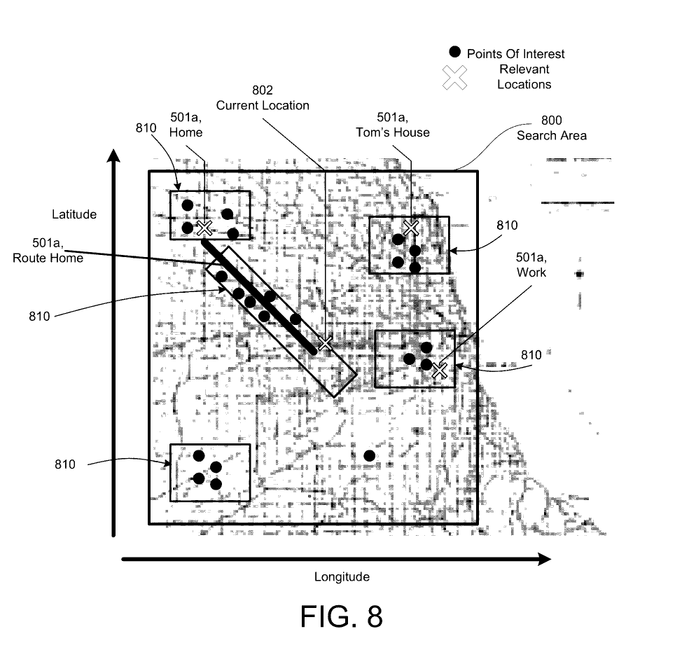

The search system 300 determines a search area 800, such as a geo-fence (see FIG. 8) based on the query wrapper 210 to restrict the search to location-based refinements 220b located within the search area 800. In some examples, the location based refinements 220b include locations adjacent to the search area 800 in addition to locations within the search area 800, e.g., within a threshold distance from the border of the geo-fence, or adjacent cities bordering the search area 800. The search system 300 identifies likely relevant points of interest (POIs) 501 located within the search area 800 or likely relevant POIs 501 located within the search area 800 and adjacent to the search area 800 (e.g., when the search system 300 fails to identify likely relevant POIs 501 within the search area 800) and clusters the likely relevant POIs 501 (e.g., based on geolocation, category, and subcategory of each POI 501) into clusters 810. For example, the search system 300 clusters the POIs 501 that are within a proximity of each other, or have a similar category or subcategory. The search system 300 scores the clusters 810 based on their geographic relevance (how relevant is the general location of the cluster 810) to the search area 800. At least some of the clusters 810 are assigned a category, such as a name that is indicative of a location (e.g., home, work, near I-280, Union Square, north of me, east of me). The search system 300 generates the location-based refinements 220b based on the category and the search query 212 (e.g., “late night diners east of me” or “late night diners off of I-280”) and sends the location-based refinements 220b to the user 10 as part of the search results 220. In some examples, the search results 220 include only location-based refinements 220b, as shown in FIG. 2B.

Location-based refinements 220b may have a geographical significance to the user 10, making them personalized to the user 10, e.g., “late night diners on my way home.” The GUI 218 of the user device 200 displays the location-based refinements 220b as displayed location-based refinement 250. When the user 10 selects a displayed location-based refinement 250, the search system 300 executes the second search associated with the corresponding location-based refinement 220b and based on a refined query wrapper 230. Therefore, when the user 10 enters a search query 212 associated with a physical location, such as, but not limited to, retail stores, bars, restaurants, coffee shops, apartments, dinning, etc., some examples of location-based refinements 220b may include, but are not limited to, Chinese restaurants near work, Chinese restaurants near me, Chinese restaurants on my way home, Coffee shops near I-280, Coffee shops north of me, McDonalds south of me, Lofts for rent at City Center, Lofts for rent in Union Square, Houses for sale near State St. and Main St.

The displayed location-based refinement 250 may include an entity 601 (e.g., “Chinese restaurant,” “coffee shops,” or “McDonalds”) and language indicative of a location (e.g., “near work,” “north of me,” “in Union Square”, “State St. and Main St.”). As shown in FIG. 1A, the first displayed location-based refinement 250a includes “late night diners” as an entity 601 and “North of me” as the location. The second displayed location-based refinement 250a also includes “late night diners” as the entity and “Near office” as the location. When the user 10 selects the first displayed location-based refinement 250a, the search system 300 executes the second search using the first displayed location-based refinement 250a as a query 212 (e.g., a refined search query 221), while when the user 10 selects the second displayed location-based refinement 250b, the search system 300 executes the second search using the second displayed location-based refinement 250a as the query 212. In other words, displayed location-based refinements 250 provide the user 10 with additional query options that allow the search system 300 to further narrow an executed search based on personalized information, e.g., north of me, near office, etc.

In some implementations, the location-based refinement 220b (i.e., displayed location-based refinement 250) includes a refined search query 221. The refined search query 221 is a search query 212 that incorporates the information contained in the location-based refinement 220b. In some implementations, the refined search query 221 includes an entity 601 and location data/text. The location data may be a bounding box corresponding to the location imparted by the refinement (e.g., two geographic coordinates), a point (e.g., geographic coordinate) and a radius, or natural language (e.g., the language shown in the location-based refinement). The refined search query 221 may be a URL (e.g., www.examplesearchapp.com/search?find=Chinese+Restuarant&find_loc=41.5982,−83.1786&radius=1 mile) or a plain text search query 212 (Chinese Restaurant within 1 mile of 41.5982,−83.1786). The refined search query 221 may have extra associated metadata in addition to the string, such as the precise parameters of the original search, or even details about a recommended modified search. For example, when the user 10 selects one of the result query links 250, the user device 200 sends a refined query wrapper 230 to the search system 300. The refined query wrapper 230 includes the selected refined search query 221. In addition, the refined query wrapper 230 may include: device location data 206 (e.g., geo-location) that indicates the location of the user device 200, such as latitude and longitude coordinates; an IP address 209, which the search module 310 may use to determine the location of the user device 200; platform data 208 (e.g., version of the operating system 224, device type, and web-browser version); an identity of the user 10 of the user device 200 (e.g., a username); partner specific data; and/or other data. The additional information of the refined query wrapper 230 may be similar to the additional information of the query wrapper 210. The search system 300 receives the user's selection of the selected refined search query 221, and the search system 300 executes the second search. Once the second search is executed, the search system 300 sends the refined search results 240 to the user device 200.

Referring to FIGS. 2A and 2B, the search system 300 may be configured to send the search results 220 and the refined search results 240, and alternatively the user device 200, may be configured to receive and display the search results 220 and the refined search results 240 in multiple ways. Referring to FIG. 2A, in some implementations, the user device 200 sends a query wrapper 210 and as a result of sending the query wrapper 210, receives search results 220. The user device 200 generates user selectable links 250, 260, 270 based on the received search results 220. Each user selectable link 250, 260, 270 displayed to the user 10 may include an access mechanism 202. The user 10 may select the user selectable link 250, 260, 270 on the user device 200 by interacting with the user selectable link 250, 260, 270 (e.g., by touching or clicking the link 250, 260, 270). In response to selection of the user selectable link 250, 260, 270, the user device 200 may launch a corresponding software application 204 (e.g., a native application 204a or a web-browser application 204b) referenced by the access mechanism 202 and perform one or more operations indicated in the access mechanism 202. The user selectable links 250, 260, 270 may include a header 260 associated with an application 204 and a result link 270 associated with the application 204. In addition, the links 250, 260, 270 may include a result query link 250 (i.e., displayed location-based refinement 250) that once selected, triggers the search system 300 to initiate a second search.

Access mechanisms 202 may include at least one of a native application access mechanism 202a (hereinafter “application access mechanism”), a web access mechanism 202b, and an application download mechanism 202c. The user device 200 may use the access mechanisms 202 to access functionality of applications 204. For example, the user 10 may select the user selectable link 250, 260, 270 including an access mechanism 202 in order to access functionality of an application 204 indicated in the user selectable link 250, 260, 270. The search module 310 may transmit one or more application access mechanisms 202a, one or more web access mechanisms 202b, and one or more application download mechanisms 202c to the user device 200 in the search results 220.

An application access mechanism 202a may be a string that includes a reference to a native application 204a and indicates one or more operations for the user device 200 to perform. If the user 10 selects a user selectable link 250, 260, 270 including an application access mechanism 202a, the user device 200 may launch the native application 204a referenced in the application access mechanism 202a and perform the one or more operations indicated in the application access mechanism 202a.

An application access mechanism 202a includes data that the user device 200 may use to access functionality provided by a native application 204a. For example, an application access mechanism 202a includes data that causes the user device 200 to launch a native application 204a and perform a function associated with the native application 204a. Performance of a function according to the access mechanism 202 may set the native application 204a into a specified state. Accordingly, the process of launching a native application 204a and performing a function according to an application access mechanism 202a may be referred to herein as launching the native application 204a and setting the native application 204a into a state that is specified by the application access mechanism 202a. In some examples, an application access mechanism 202a for a restaurant reservation application includes data that causes the user device 200 to launch the restaurant reservation application and assist in making a reservation at a restaurant. In such examples, the restaurant reservation application may be set in a state that displays reservation information to the user 10, such as a reservation time, a description of the restaurant, and user reviews. In additional examples, an application access mechanism 202a for an internet media player application includes data that causes the user device 200 to launch the internet media player application and stream media from the Internet. In such examples, the internet media player application may be set in a state that displays information regarding the media (e.g., music) being streamed, such as a song name, an artist, or an album name.

Application access mechanisms 202a may have various different formats and content. The format and content of an application access mechanism 202a may depend on the native application 204a with which the application access mechanism 202 is associated and the operations that are to be performed by the native application 204a in response to selection of the application access mechanism 202a. For example, an application access mechanism 202a for an internet music player application may differ from an application access mechanism 202a for a shopping application. An application access mechanism 202a for an internet music player application may include references to musical artists, songs, and albums, for example. The application access mechanism 202a for an internet music player application may also reference operations, such as randomizing a list of songs and playing a song or album. An application access mechanism 202a for a shopping application may include references to different products that are for sale. The application access mechanism 202a for the shopping application may also include references to one or more operations, such as adding products to a shopping cart and proceeding to a checkout.

The search system 300 transmits additional data in the search results 220 along with the application access mechanisms 202a. For example, the search system 300 may transmit data (e.g., link data 252, 262, 272, such as text and/or images), which may be used by the user device 200 to generate user selectable links 250, 260, 270 in the search results 220. A link 250, 260, 270 may include text and/or images that the user 10 may select (e.g., touch) via a graphical user interface 218 displayed on a screen 201 (e.g., a display or touch screen) of the user device 200. Each user selectable link 250, 260, 270 may be associated with an application access mechanism 202a such that when the user 10 selects a link 250, 260, 270, the user device 200 launches the native application 204a referenced in the application access mechanism 202a and performs the one or more operations indicated in the application access mechanism 202a. The text and/or images of a link 250, 260, 270 displayed to the user 10 may indicate the operations that maybe performed in response to selection of the link 250, 260, 270. For example, if the link 260, 270 associated with the organic search results 220a is to a song in a music playing application, the text and/or images may identify the music application that may be launched by the user device 200 and the song that may be played by the music playing application when the user 10 selects the link 260, 270. If the user 10 selects the link 250 associated with the location-based refinement 220b, the link 250 triggers the user device 200 to send a refined query wrapper 230 to the search system 300 to re-query the databases 330, 340 of the search system 300 and return refined search results 240. The user 10 may select a link 260, 270 to cause the user device 200 to launch the native application 204a identified in the link 260, 270 and perform one or more operations according to the application access mechanism 202a associated with the link 260, 270. Put another way, when the user 10 selects a link 260, 270 the user device 200 launches a native application 204a and sets the native application 204a into a state defined by the application access mechanism 202a associated with the link 260, 270. In general, a state of a native application 204a may refer to the operations and/or the resulting outcome of the native application 204a in response to selection of a link 260, 270. A state of a native application 204a may also be referred to herein as an “application state.”

An application state specified by an application access mechanism 202a may depend on the functionality provided by the native application 204a. For example, if a native application 204a is configured to retrieve and display information from the Internet, the native application 204a can be set into a state in which the native application 204a retrieves information from the Internet and displays information to the user 10. In another example, if a native application 204a is configured to play media (e.g., music and/or video) from the Internet, the native application 204a can be set into a state in which the native application 204a is playing a song or a movie from the Internet. In another example, if a native application 204a is configured to make restaurant reservations, the native application 204a can be set into a state in which the native application 204a displays available restaurant reservations to the user 10.

A web access mechanism 202b may include a resource identifier that includes a reference to a web resource (e.g., a page of a web application/website). For example, a web access mechanism 202b may include a uniform resource locator (URL) (i.e., a web address) used with hypertext transfer protocol (HTTP). If the user 10 selects a user selectable link 250, 260, 270 including a web access mechanism 202b, the user device 200 may launch the web browser application 204b and retrieve the web resource indicated in the resource identifier. Put another way, if the user 10 selects a user selectable link 250, 260, 270 including a web access mechanism 202b, the user device 200 may launch a corresponding web-browser application 204b and access a state (e.g., a page) of a web application/website. In some examples, web access mechanisms 202b include URLs for mobile-optimized sites and/or full sites.

The web access mechanism 202b included in an application state record 400 may be used by a web browser to access a web resource that includes similar information and/or performs similar functions as would be performed by a native application 204a that receives an application access mechanism 202a of the application state record 400. For example, the web access mechanism 202b of an application state record 400 may direct the web-browser application 204b of the user device 200 to a web version of the native application 204a referenced in the application access mechanisms 202a of the application state record 400. Moreover, if the application access mechanisms 202 included in an application state record 400 for a specific Mexican restaurant cause each application edition to retrieve information for the specific Mexican restaurant, the web access mechanism 202b may direct the web-browser application 204b of the user device 200 to a web page entry for the specific Mexican restaurant.

An application download mechanism 202c may indicate a location (e.g., a digital distribution platform 130b) where a native application 204a can be downloaded in the scenario where the native application 204a is not installed on the user device 200. If the user 10 selects a user selectable link 250, 260, 270 that includes an application download mechanism 202a, the user device 200 may access a digital distribution platform from which the referenced native application 204a may be downloaded. The user device 200 may access a digital distribution platform 130b using at least one of the web-browser application 204b and one of the native applications 204a.

An application access mechanism 202a included in an application state record 400 may be an application resource identifier or a string that includes a reference to a native application 204a and/or indicates one or more operations for execution by the native application 204a on the user device 200. An application resource identifier may be a string having an application specific scheme, in some examples. For example, the application resource identifier may include a reference to a native application 204a, a domain name, and a path to be used by the native application 204a to retrieve and display information to the user 10. In some examples, an application resource identifier is an application specific resource identifier that is defined by the developer of the application 204. In this example, the search application 216 receives the application resource identifier and the operating system 228 may send the application resource identifier to the native application 204a referenced in the application resource identifier. The native application 204a referenced in the application resource identifier launches and is set into the state specified by the application resource identifier.

In some examples, the application access mechanism 202a includes operations for the user device 200 to perform in addition to the operation(s) indicated in the application resource identifier. For example, the search application 216, the operating system 228, and/or a native application 204a on the user device 200 may perform the operations included in the application access mechanism 202a. In some examples, a script includes the operations. Examples of operations may include, but are not limited to, launching a native application 204a, creating and sending a search query 212 (via a query wrapper 210) to an application server 112, setting a current geographic location in a native application 204a, making a restaurant reservation, sending a text message, and adding an appointment to a calendar.

In some examples, an application access mechanism 202a does not include an application resource identifier. Instead, the application access mechanism 202a includes one or more operations that reference a native application 204a and indicate one or more operations for execution by the user device 200. The one or more operations may include instructions for at least one of the search application 216, the operating system 228, and/or a native application 204a on the user device 200. In response to selection of the application access mechanism 202a, the user device 200 may perform the operations included in the application access mechanism 202a. In some examples, the operations are included in a script.

In some examples, an application function is not accessible using an application resource identifier. For example, a function of the application 204 may not include a corresponding application resource identifier that the application 204 may use to perform the function. As another example, some applications 204 may not be configured to receive application resource identifiers. In these examples, an application access mechanism 202 for the native application 204a includes one or more operations that cause the native application 204a to perform the function that may not otherwise be accessible using an application resource identifier. For example, the search application 216 may receive the one or more operations and execute the one or more operations to set the native application 204a into the desired application state. In some examples, the one or more operations include launching the native application 204a along with additional operations for the native application 204a to perform. For example, the search application 216 may initially trigger the native application 204a to start and then wait for a period of time for the native application 204a to start. Then the search application 216 may perform additional operations included in the received application access mechanism 202, such as issuing a search instruction to the native application 204a.

In still other examples, a native application 204a may be configured to directly receive the operations transmitted by the search system 300. In these examples, the native application 204a may be launched according to the application access mechanism 202 and then the launched native application 204a may directly perform the operations received from the search system 300.

A single native application 204a may provide a variety of different functionalities. For example, a restaurant reservation application accesses reviews for a variety of different restaurants and set up reservations at a variety of different restaurants. Similarly, a travel application may book hotels, book flights, and provide reviews for different travel destinations. The different functionalities associated with a single native application 204a may be accessed using a plurality of different application access mechanisms 202. For example, with respect to the restaurant reservation application, the application data store 330 may include application state records 400 having different application access mechanisms 202 for accessing different restaurant reviews and setting up reservations. Similarly, the application data store 330 may include application state records 400 having different application access mechanisms 202 for booking hotels, booking flights, and accessing reviews for different travel destinations.

The application access mechanisms 202 for a single native application 204a may vary in complexity. In some examples, the application access mechanisms 202 cause a native application 204a to launch (e.g., the operating system 228 may be instructed to launch the application 204) and then perform additional operations after launching, as described above. In other examples, application access mechanisms 202 may cause an application 204 to launch into a default state (e.g., a default homepage) without performing any additional operations. An application state record 400 including an application access mechanism 202 that causes an application 204 to launch into a default state may be thought of as an access mechanism 202 that is related to the native application 204a, but not any particular state, which may be accessed by the application 204.

In some examples, the search application 216 is a native application 204a installed on the user device 200. For example, the search application 216 may receive search queries 212, generate the query wrapper 210, and display received data that is included in the search results 220. In additional examples, the user device 200 may execute a web-browser application 204b that accesses a web-based search application. In this example, the user 10 may interact with the web-based search application via a web-browser application 204b installed on the user device 200. In still more examples, the functionality attributed to the search application 216 may be included as a searching component of a larger application 204 that has additional functionality. For example, the functionality attributed to the search application 216 may be included as part of a native/web-browser application 204a, 204b as a feature that provides search for the native/web-browser application 204a, 204b.

Referring to FIG. 2B, in some examples, the user device 200 displays the location-based refinement 220b without displaying the organic results 220a as shown in FIG. 2A. Therefore, if the user 10 enters a search query 212 for ‘late night diners’, the results list 251 includes, for example, Late night diners north of me 250a, late night diners near office 250b, late night diners on my way home 250d, late night diners off of I-280, late night Diners on my way to Joes' 250e, and late night diners on my way to mom's 250f. Each of these links 250 (e.g., displayed location-based refinement 250) triggers or initiates a narrower search of the entity 601 late night dinner in a location near the specified location within the link, i.e., North of me, near office, on my way home, off of I-280, on my way to Joe's, and on my way to Mom's. In this case, the user 10 may select one of the links 250, which triggers the user device 200 to send a refined query wrapper 230 including the selected refined search query 221 to the search system 300. As previously discussed, the refined query wrapper 230 may include device location data 206 (e.g., geo-location), platform data 208, and/or an IP address 209.

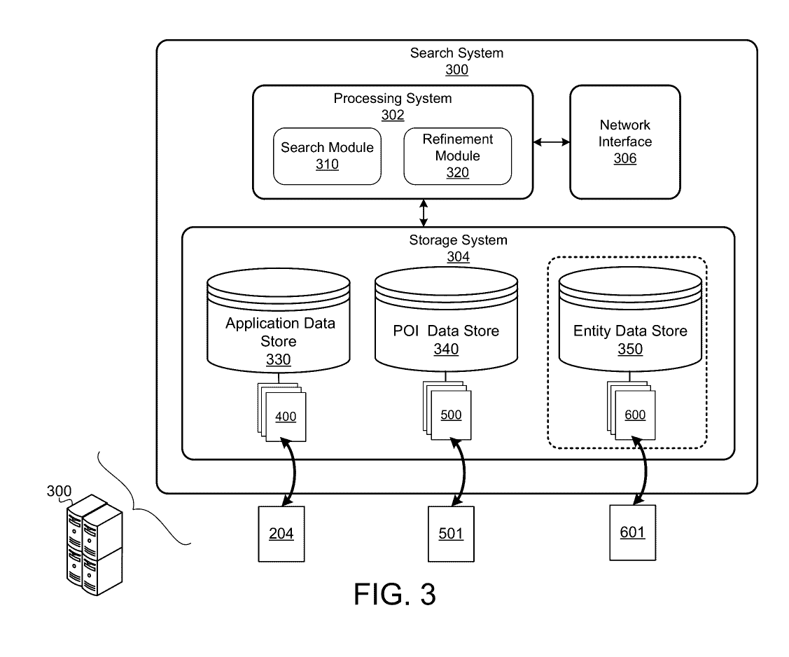

Referring to FIG. 3, in some implementations, the search system 300 includes a processing system 302 and a storage system 304. As shown, the processing system 302 includes the search module 310 and the refinement module 320. However, in other examples, the refinement module 320 may be independent from and in communication with the processing system 302 or may be part of the search module 310. The storage system 304 includes an application data store 330 for storing application state records 400, a point of interest (POI) data store 340 for storing POI records 500, and optionally an entity data store 350 for storing entity records 600. In some examples, the POI data store 340 includes POI records 500 received from third party sources and stored in the POI data store 340. In other examples, the search system 300 may be in communication with the POI data store 340 (via the network 120), which is separate and independent from the search system 300 and maintained by a third-party. In this example, the search system 300 may communicate with the POI data store 340 of the third party through an application program interface (API). The search system 300 includes a network interface 306. The network interface 306 includes one or more devices that perform wired or wireless (e.g., Wi-Fi or cellular) communication. Examples of the network interface devices include, but are not limited to, a transceiver configured to perform communications using the IEEE 802.11 wireless standard, an Ethernet port, a wireless transmitter, and a universal serial bus (USB) port. The search module 310 receives the query wrapper 210 and generates the search results 220 that include the organic results 220a and location-based refinements 220b based on data included in the storage system 304.

Referring to FIGS. 4A and 4B, the application data store 330 includes a plurality of different application state records 400. Each application state record 400 may include data related to a function of an application 204 and/or the state of the application 204 resulting from performance of the function. An application state record 400 may include an application state identifier (ID) 410, application state information 420, an application identifier (ID) 420a, and one or more access mechanisms 202, 202a, 202b, 202c used to access functionality provided by an application 204.

The application state ID 410 may be used to identify the application state record 400 among the other application state records 400 included in the application data store 330. In some implementations, an application state ID 410 is a string of alphabetic, numeric, and/or symbolic characters (e.g., punctuation marks) that uniquely identify a state of an application 204. Put another way, an application state ID 410 may be a unique reference to a state of an application. In some implementations, an application state ID 410 is in the format of a resource identifier. For example, the application state ID 410 may be a uniform recourse locator (URL) or an application resource identifier. In these implementations, the application state ID 410 may be used by the user device 200 to access a web application or one or more editions of a native application 204a, respectively. In some implementations, an application state ID 410 maps to one or more access mechanisms 202. In these implementations, the application state ID 410 may map to a web resource identifier (e.g., a URL) and/or one or more application resource identifiers. For instance, a state of an example software application, example app, may be accessed via a web application edition and two native application editions (e.g., an edition configured for the ANDROID® operating system and an edition configured for the WINDOWS PHONE® operating system). In this example, the web resource identifier may be www.exampleapp.com/param1=abc&param2=xyx, the first application resource identifier may be android.exampleapp::param1=abc&param2=xyx, and the second application resource identifier may be windows.exampleapp::param1=abc&param2=xyx. In this example, an application state ID 410 maps to the web resource identifier and the two application resource identifiers. An application state ID 410 may have a URL-like structure that utilizes a namespace other than http://, such as “func://”, which indicates that the string is an application state ID 410. In the example of“exampleapp” above, the application state ID 410 corresponding to the example state may be func://exampleapp::param1=abc&param2=xyx, which maps to the access mechanisms 202 described above. In another example, an application state ID 410 may take the form of a parameterizable function. For instance, an application state ID 410 may be in the form of “app_id[action(parameter_1, . . . , parameter_n)], where app_id is an identifier (e.g., name) of a software application, action is an action that is performed by the application (e.g., “view menu”), and parameter_1 . . . parameter_n are n parameters that the software application receives in order to access the state corresponding to the action and the parameters. Drawing from the example above, an application state ID 410 may be “exampleapp[example_action(abc, xyz)]. Given this application state ID 410 and the referencing schema of the example application, the foregoing application state ID 410 may be used to generate the access mechanisms 202 defined above. Additionally or alternatively, the above example application state ID 410 may map to the access mechanisms 202 defined above. Furthermore, while application state IDs 410 have been described with respect to resource identifiers, an application state ID 410 may map to one or more scripts that access a state of a software application or may be utilized to generate one or more scripts that access a state of the software application. Some software applications may have a common scheme for accessing all of their respective native application editions. In such scenarios, a single application resource identifier may access multiple application editions.

In a more specific example, if the application state record 400 describes a function of the YELP native application, the application state ID 410 may include the name “Yelp” along with a description of the application state described in the application state information 420. For example, the application state ID 410 for an application state record 400 that describes the restaurant named “The French Laundry” may be “Yelp—The French Laundry.” In an example where the application state ID 410 includes a string in the format of a URL, the application state ID 410 may include the following string “http://www.yelp.com/biz/the-french-laundry-yountville-2?ob=1” to uniquely identify the application state record 400. In additional examples, the application state ID 410 may include a URL using a namespace other than “http://,” such as “func://,” which may indicate that the URL is being used as an application state ID 410 in an application state record 400. For example, the application state ID 410 may include the following string “func://yelp/biz/the-french-laundry-yountville-2?ob=1.”

The application state information 420 may include data that describes an application state into which an application 204 is set according to the access mechanism(s) 202 in the application state record 400. Additionally or alternatively, the application state information 420 may include data that describes the function performed according to the access mechanism(s) 202 included in the application state record 400. The application state information 420 may include text, numbers, and symbols that describe the application state. The types of data included in the application state information 420 may depend on the type of information associated with the application state and the functionality specified by the application access mechanism 202a. The application state information 420 may include a variety of different types of data, such as structured, semi-structured, and/or unstructured data. The application state information 420 may be automatically and/or manually generated based on documents retrieved from the data sources 130. Moreover, the application state information 420 may be updated so that up-to-date search results 220 may be provided in response to a search query 212.

In some examples, the application state information 420 includes data that is presented to the user 10 by an application 204 when the application 204 is set in the application state defined by the access mechanism(s) 202. For example, if one of the access mechanism(s) 202 is an application access mechanism 202a, the application state information 420 may include data that describes a state of the native application 204a after the user device 200 has performed the one or more operations indicated in the application access mechanism 202a. For example, if the application state record 400 is associated with a shopping application, the application state information 420 may include data that describes products (e.g., names and prices) that are shown when the shopping application is set to the application state defined by the access mechanism(s) 202. As another example, if the application state record 400 is associated with a music player application, the application state information 420 may include data that describes a song (e.g., name and artist) that is played when the music player application is set to the application state defined by the access mechanism(s) 202.

The types of data included in the application state information 420 may depend on the type of information associated with the application state and the functionality defined by the access mechanism(s) 202. For example, if the application state record 400 is for an application 204 that provides reviews of restaurants, the application state information 420 may include information (e.g., text and numbers) related to a restaurant, such as a category of the restaurant, reviews of the restaurant, and a menu for the restaurant. In this example, the access mechanism(s) 202 may cause the application 204 (e.g., a native application 204a or a web-browser application 204b) to launch and retrieve information for the restaurant. As another example, if the application state record 400 is for an application 204 that plays music, the application state information 420 may include information related to a song, such as the name of the song, the artist, lyrics, and listener reviews. In this example, the access mechanism(s) 202 may cause the application 204 to launch and play the song described in the application state information 420.

The search system 300 may generate application state information 420 included in an application state record 400 in a variety of different ways. In some examples, the search system 300 retrieves data to be included in the application state information 420 via partnerships with database owners and developers of native applications 204a. For example, the search system 300 may automatically retrieve the data from online databases 130f that include, but are not limited to, data related to movies, television programs, music, and restaurants. In some examples, a human operator manually generates some data included in the application state information 420. The search system 300 may update data included in the application state information 420 over time so that the search system 300 provides up-to-date search results 220.

The application ID 420a may be used to identify a native application 204a associated with the application state record 400. The application ID 420a may be a string of alphabetic, numeric, and/or symbolic characters (e.g., punctuation marks) that uniquely identifies the associated native application 204a. In some examples, the application ID 420a is a native application 204a in human readable form. For example, the application ID 420a may include the name of the application 204 referenced in the access mechanism(s) 202. In a specific example, the application ID 420a for a restaurant finder application 204 may include the name of the restaurant finder application.

An application state record 400 including an application access mechanism 202 that causes an application 204 to launch into a default state may include application state information 420 describing the native application 204a, instead of any particular application state. For example, the application state information 420 may include the name of the developer of the application 204, the publisher of the application 204, an application identifier (ID) 420a identifying the application associated with the application state record 400, a keyword 420b relating to the access mechanism 202, a category 420c (e.g., genre) of the application 204, location data 420d associated with the application state record 400 or the application 204 providing the application ID 420a, a description of the application 204 (e.g., a developer's description), and the price of the application 204, or any other relevant data. The application state information 420 may also include security or privacy data about the application 204, battery usage of the application 204, and bandwidth usage of the application 204. The application state information 420 may also include application statistics. Application statistics may refer to numerical data related to a native application 204a. For example, application statistics may include, but are not limited to, a number of downloads, a download rate (e.g., downloads per month), a number of ratings, and a number of reviews.

In some implementations, an application state record 400 includes multiple different application access mechanisms 202, 202a, 202b, 202c that include a variety of information. The application access mechanism 202 may include edition information that indicates the application edition with which the application access mechanism 202 is compatible. For example, the edition information may indicate the operating system 224 with which the application access mechanism 202 is compatible. Moreover, different application access mechanisms 202 may be associated with different editions of a native application 204a. A native application edition (hereinafter “application edition”) refers to a particular implementation or variation of a native application 204a. For example, an application edition may refer to a version of a native application 204a, such as a version 1.0 of a native application 204a or a version 2.0 of a native application 204a. In another example, an application edition may refer to an implementation of a native application 204a for a specific platform, such as a specific operating system 224.

The different application access mechanisms 202 included in an application state record 400 may cause the corresponding application editions to launch and perform similar functions. Accordingly, the different application access mechanisms 202 included in an application state record 400 may cause the corresponding application editions to be set into similar application states. For example, if the different application access mechanisms 202 reference different editions of an information retrieval application, the different application access mechanisms 202 may cause the corresponding application editions to retrieve similar information. In another example, if the different application access mechanisms 202 reference different editions of an internet music player application, the different application access mechanisms 202 may cause the corresponding application editions to play the same song.

In some examples, an application state record 400 for a native application that retrieves restaurant information includes multiple different application access mechanisms 202 for multiple different application editions. Assuming the application state record 400 is associated with a specific Mexican restaurant, the application access mechanisms 202 for the different application editions may cause each application edition to retrieve information for the same specific Mexican restaurant. For example, a first application access mechanism 202 may cause a first application edition (e.g., on a first OS) to retrieve information for the specific Mexican restaurant. A second application access mechanism 202 may cause a second application edition (e.g., on a second OS) to retrieve information for the specific Mexican restaurant. In some examples, the search system 300 determines whether to transmit the application access mechanism 202 in the search results 220 based on whether the user device 200 can handle the application access mechanism 202.

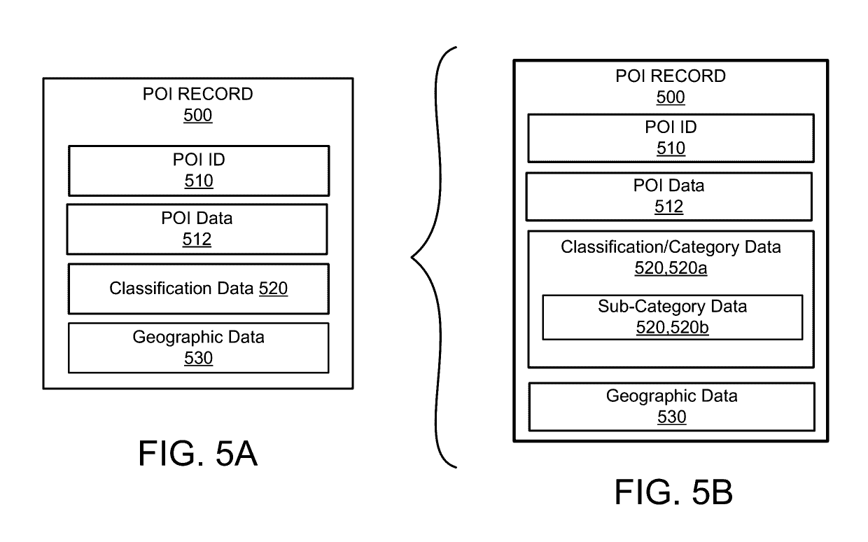

Referring to FIGS. 5A and 5B, the POI data store 340 includes a plurality of different POI records 500. Each POI record 500 may include data related to a POI 501. A POI 501 is a specific point location that is useful or interesting to the user 10. For example, a POI 501 may be a restaurant, a shopping center, or a coffee store to name a few. Each POI record includes a POI identifier or name (ID) 510, classification data 520, which includes one or more categories associated with the POI 501, and geographic data 530 that includes the location of the POI 501.

The POI ID 510 may be used to identify the POI record 500 among the other POI records 500 included in the POI data store 340. The POI ID 510 may be a string of alphabetic, numeric, and/or symbolic characters (e.g., punctuation marks) that uniquely identifies the associated entity record 600. In some examples, the POI ID 510 describes the POI 501 in a human readable form. For example, the POI ID 510 may include a name of the POI 501 or a string in human readable form identifying the POI 501. In other implementations, the POI ID 510 may be a unique number that identifies the POI.

In a more specific example, if the POI record 500 describes a restaurant named Qdoba® (QDOBA is a registered trademark of Qdoba Restaurant Corporation), the POI ID 510 for the POI 500 can include the text “Qdoba.” In an example where the POI ID 510 includes a string in human readable form, the POI ID 510 may include the following string “Qdoba, 42967 Woodward Avenue, Bloomfield Township, Mich. 48304” to uniquely identify the entity record 600. Other unique identifiers are possible as well, such a store number.

The POI data 512 may include any information about the POI 501, such as text (e.g., description, reviews) and numbers (e.g., number of reviews). This information may even be redundant to other information contained in the POI record 500, but optionally structured for display, for example. The POI record 500 may include a variety of different types of data, such as structured, semi-structured, and/or unstructured data. Moreover, the POI record 500 may be automatically and/or manually generated based on documents retrieved from the data sources 130.

The POI classification data 520 provides a classification or grouping of the POIs 501. Moreover, the POI classification data 520 can have one or more sub-categories to further classify the POIs 501. For example, the POI record 500 can have a POI classification data 520a of “restaurant” and a sub-category 520b of a type of cuisine, such as “French cuisine” or “contemporary.” Any number of categories 520a and sub-categories 520b may be assigned to classify the POI 501 for use during a search.

The geographic data 530 may include data that describes a location of the entity 601. This data may include a geolocation (e.g., latitude and longitude coordinates), a street address, or any information that can be used to identify the location of the entity 601. In some implementations, the entity location data 606 defines a geo-location associated with the application state record 400.

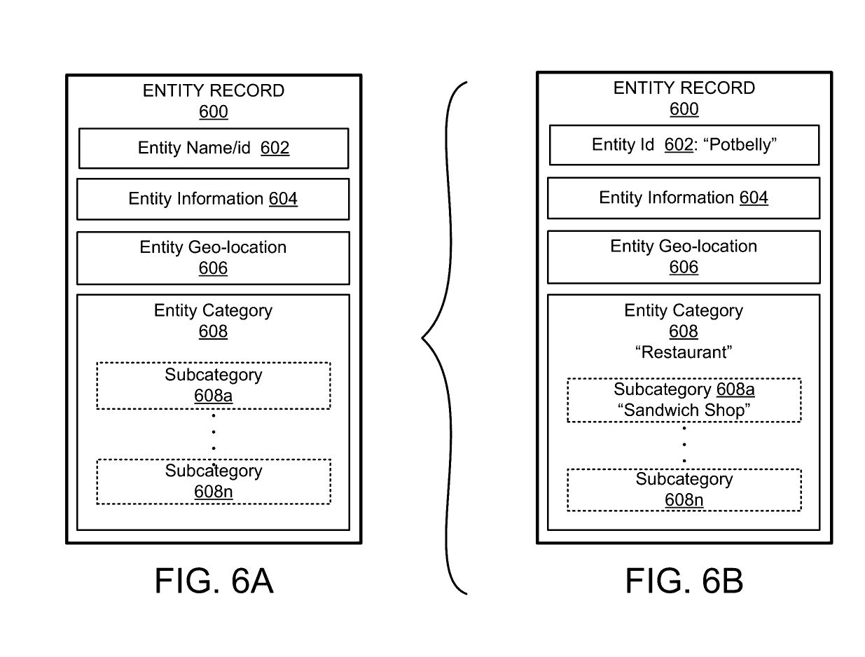

Referring to FIGS. 6A and 6B, the entity data store 350 includes a plurality of entity records 600. Each entity record 600 may include data related to an entity 601. The entity 601 can be a business or place with a geolocation or person or event (e.g., restaurants, bars, gas stations, supermarkets, movie theaters, doctor offices, sports team, movie star, celebrity, politician, parks, and libraries, etc.). An entity record 600 may include an entity identifier or name (ID) 602, entity location data 606 (e.g., geolocation data), an entity category 608 (and optionally one or more sub-categories 608a-608n), and/or entity information 604.

The entity ID 602 may be used to identify the entity record 600 among the other entity records 600 included in the entity data store 350. The entity ID 602 may be a string of alphabetic, numeric, and/or symbolic characters (e.g., punctuation marks) that uniquely identifies the associated entity record 600. In some examples, the entity ID 602 describes the entity 601 in human readable form. For example, the entity ID 602 may include the name string of the entity 601 or a human readable identifying the entity 601. In some examples, the entity ID 602 includes a unique number that identifies the entity.

In a more specific example, if the entity record 600 describes a restaurant named Potbelly®, the entity ID 602 for the entity record 600 can be “Potbelly.” In an example where the entity ID 602 includes a string in human readable form and/or a URL, the entity ID 602 may include the following string “Potbelly” to uniquely identify the entity record 600. Other unique identifiers are possible as well, such a store number.

The entity information 604 may include any information about the entity 601, such as text (e.g., description, reviews) and numbers (e.g., number of reviews). This information may even be redundant to other information contained in the entity record 600, but optionally structured for display, for example. The entity information 604 may include a variety of different types of data, such as structured, semi-structured, and/or unstructured data. Moreover, the entity information 604 may be automatically and/or manually generated based on documents retrieved from the data sources 130.

The entity location data 606 may include data that describes a location of the entity 601. This data may include a geolocation (e.g., latitude and longitude coordinates), a street address, or any information that can be used to identify the location of the entity 601. In some implementations, the entity location data 606 defines a geo-location associated with the application state record 400.

The entity category 608 provides a classification or grouping of the entity 601. Moreover, the entity category 608 can have one or more sub-categories 608a to further classify the entity 601. For example, the entity record 600 could have an entity category 608 of “restaurant” and a sub-category 608a of a type of cuisine, such as “Sandwich Shop,” “French cuisine,” or “contemporary.” Any number of sub-categories 608a-608n may be assigned to classify the entity 601 for use during a search.

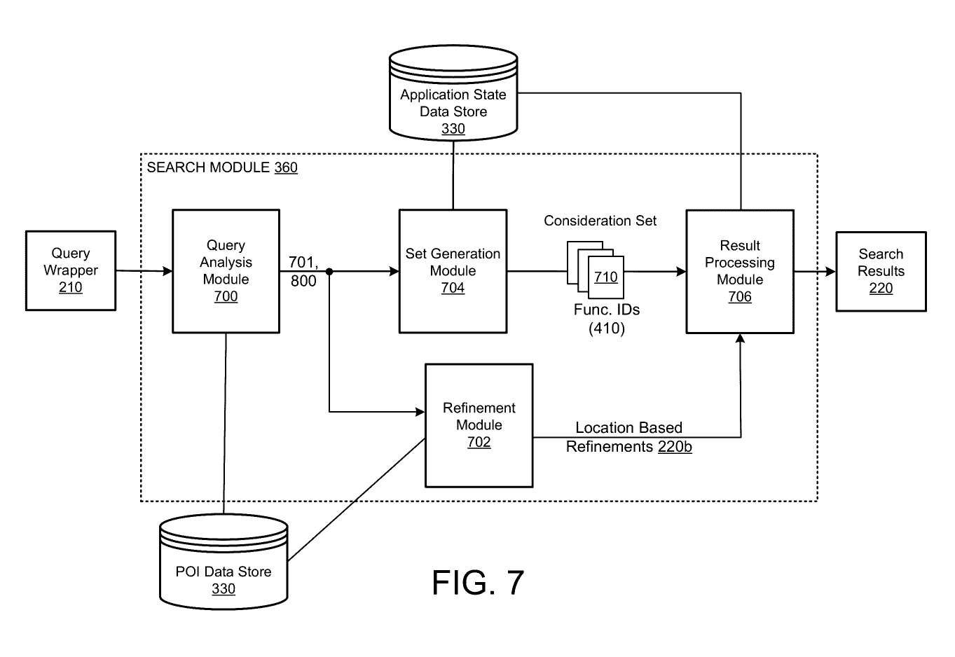

FIG. 7 shows an example search module 360 that includes a query analysis module 700, a set generation module 704, a refinement module 702, and a result processing module 706. The query analysis module 700 receives the query wrapper 210 and analyzes the received search query 212 of the query wrapper 210. The query analysis module 700 may perform various analysis operations on the received search query 212. The analysis operations may include, but are not limited to, tokenization of the search query 212, filtering of the search query 212, stemming, synonymization, and stop word removal. In some implementations, the query analysis module 700 detects a query-specified location included in the text string of the search query 212.

The query analysis module 700, in some examples, parses and analyses the search query 212 to determine a search area 800 associated with the query 212 and based on the search location. The search location, for example, may be a current position 802 of the user device 200 received from the query wrapper 210, or a search location determined from the text string of the search query 212. The search area 800 may define a geographic area (e.g., a city, a street within a city, a street intersection, or any other geographical identifier) that relates to the search query 212. The search system 300 narrows its search to the search area 800. In some implementations, the search area 800 is a geo-fence. The geo-fence may be any suitable shape, including a square, a circle, an oval, a diamond, a triangle, or a combination thereof. Other shapes may be possible as well. In some implementations, the size (i.e. area) of the search area 800 depends on the density of the area. For examples, rural areas where POIs 501 are spread out may have larger search areas 800 than urban areas where the POIs may be condensed together. For example, in New York the search area may be smaller than a search area in rural areas.

The search area 800 may be based on a current location 802 of the user device 200 or can be derived from the search query 212 itself (e.g., from the text of the search query 212, or from the geo-location data 206 and/or the IP address 209 received as part of the query wrapper 210). For example, if the user 10 is looking for Thai food and enters in the search box 214 the search query 212 as “Thai food,” the query analysis module 700 assumes that the user 10 is searching for Thai food within his or her current location 802, because no other location is specified in the search query 212. Therefore the search system 300 uses the location 802 of the user device 200 received from the query wrapper 210 (e.g., the geo-location data 206 and/or the IP address 209). If the search query 212 includes an explicit reference to a location, the query analysis module 700 determines the search area 800 based on the explicit reference. For example, the search query 212 “Thai food in New York” may be received from a user 10 in San Francisco. In this example, the search area 800 is set to an area corresponding to New York (e.g., a geo-fence around Manhattan and/or Brooklyn). Thus, an explicit reference to a location may override the current location (the geo-location data 206 and/or the IP address 209 received as part of the query wrapper 210) of the user device 200 when determining the search area. Once the query analysis module 700 determines the search location associated with the search query 212, the query analysis module 700 determines the border of the search area 800. When the search area 800 is a circle, the query analysis module 700 determines a center point and a radius of the circle. When the search area 800 is a rectangle, the query analysis module 700 determines a center point, a length, and a width of the rectangle. When the search area 800 is a triangle, the query analysis module 700 determines a center point of the triangle. When the search area 800 is a polygon, the query analysis module 700 estimates a center point of the polygon. The center point may be the user device location 802 or the midpoint between the user device location 802 and a specified search location. In some examples, the center point is the center of a geographical area (e.g., “Thai food in New York”, the center point is the midpoint of New York City, which is the geographical area). As previously mentioned, the size of the search area 800 may be adjusted according to a population density of the search area 800. Possible representations of a search area 800 may include, but are not limited to: <latitude, longitude, radius> or <latitude1, longitude1, latitude2, longitude2, latitude3, longitude3, latitude4, longitude4> or <lat1, long1, lat2, long2, lat3, long3, lat4, long4> (defining the vertices of the polygon having 4 vertices. The query analysis module 700 outputs the determined search area 800 and the processed search query 701 to the set generation module 704 and the refinement module 702. The processed search query 701 may be a set of tokens or may be more complex (e.g., one or more query parses).

The refinement module 702 receives the search area 800 and the processed search query 701 and outputs location-based refinements 220b. The location-based refinement 220b may have two distinct components, a display portion (i.e., the search query link data 252) and a refined query 221. The display portion 252 is a natural language portion that is displayed to the user 10 in the result list 251 (e.g., “diners near work”). The refined query 221 is the search query that the user device 200 transmits the search system 300 in response to a user selection of the displayed location-based refinements 250 (e.g., “diners within one mile of 37.7991N, 122.4075 W”).

The refinement module 702 determines any suitable location-based refinements 220b. Upon receiving the search area 800 and the processed search query 701, the refinement module 702 identifies POIs 501 within the search area 800 that are relevant to the search query 212. In some examples, the location-based refinements 220b are located within the search area 800 and adjacent to the search area 800, e.g., within a threshold distance from the border of the geo-fence, or adjacent cities bordering the search area 800. For example, if a user searches for sushi in Mountain View, Calif., then the search system 300 may return location-based refinements 220b of sushi restaurants in cities adjacent to Mountain View, for example, sushi in Sunnyvale, and/or sushi in Los Altos and/or sushi in Los Altos Hills, and/or sushi in Palo Alto, which all share a border with, and are adjacent to Mountain View. Therefore, if the search system 300 fails to locate sushi restaurants in Mountain View, then the search system 300 returns results for sushi in the adjacent cities listed above. For example, if the search query 212 is “Sushi,” the refinement module 702 searches for sushi restaurant locations within the search area 800 or within the search area 800 and adjacent to the search area 800. In some implementations, the refinement module 702 searches the POI data store 340 using the processed search query 701 and the search area 800. The POI data store 340 returns the relevant POIs 501 within the search area 800 or within the search area 800 and adjacent to the search area 800.

The refinement module 702 then clusters/groups the POIs 501 located within the search area 800 (or adjacent to the search area 800) based on one or more features into clusters 810. The features on which the POIs are clustered include the geographic data 530 of the POIs 501 and the category 520a of the POIs 501. Furthermore, the POIs 501 may be clustered according to subcategories 502b as well. In some examples, the POI clusters 810 are based on an entity 601. Example clustering techniques are bi-clustering, k-means clustering, and k-nearest neighbor, which results in one or more POI clusters 810.

For each POI cluster 810, the refinement module 702 overlays a shape on the cluster 810. In some implementations, the refinement module 702 overlays shapes onto a map that includes the POIs 501. Once the refinement module 702 identifies the POI clusters 810, the refinement module 702 determines a best fitting shape to overlay on each POI cluster 810. For example, the refinement module 702 overlays rectangles, triangles, circles, or polygons over the POI clusters 810. Referring to FIG. 7, multiple POI clusters 810 are shown, and each POI cluster 810 has a different shape than the other POI clusters 810. One POI 501 may be part of more than one POI cluster 810, and thus, overlaid by more than one shape.

The refinement module 702 labels or names each POI cluster 810 based on a relevant POI 501a. A relevant POI 501a may be the name of a generally-known POI, a user-specific POI, or an arbitrary POI. A generally known POI 501a can be a known landmark or location (e.g., Union Square, Metro Airport, etc.) that resides in the shape surrounding the POI clusters 810. These types of POIs 501 can be obtained from the POI database (maybe the most popular POIs 501). The user-specific POI 501a is a POI 501a that is relevant to the user 10. Examples of user-specific POIs 501a are “near me,” work, home, friends and families houses, on my current route, on my drive home, etc. The user-specific POIs can be identified in various manners. The user POIs may be learned over time (user 10 drives from Home to Work every day, the POI may be ‘on my drive home’), the current location (near me), the user's contacts (e.g., Mom's House), user provided input (e.g., user 10 requests directions from location A to B). If the refinement module 702 locates a generally-known or user-specific POI within the shape defining the POI cluster 810, then the refinement module 702 labels the POI cluster 810 with the name of the generally-known POI 501a or user-specific POI 501a. If the refinement module 702 fails to locate a generally-known POI or a user-specific POI within the shape surrounding the POI cluster 810, or the located generally-known POI or user-specific POI is not a good center-point for the POI cluster 810, then the refinement module 702 assigns the POI cluster 810 a label based on a POI 501 within the POI cluster 810. In some examples, the POI 501 is an arbitrary POI 501; while in other examples, the POI 501 is a generally-known POI 501, user-specific 501, or other POI 501. An arbitrary POI 501 is a POI 501 not having any particular significance (e.g., State and Main, The Piggly Wiggly@3^{rd} Ave, 24^{th} and 1^{st}). The arbitrary POI 501 may be identified by locating a center of the shape of the POI cluster 810 and identifying the nearest named point (e.g., intersection) to the center of the shape. The name of the intersection can be used as the label of the POI cluster 810.

The refinement module 702 may score and rank each POI cluster 810 to determine which POI clusters 810 to use for determining one or more location-based refinements 220b and the order in which the location-based refinements 220b appear in the search results 251. The refinement module 702 determines a cluster score 227 for each POI cluster 810. The refinement module 702 may score the clusters in any suitable manner.

In some implementations, the refinement module 702 scores each POI 501 within a POI record 500 based on one or more POI parameters. These parameters may include, but are not limited to, distance/average proximity, POI quality/popularity, cluster tightness, user personal bias, cluster relevance, entity type (see FIG. 6), entity density, popularity density, result average density. For example, the refinement module 702 may determine a distance from the current location 802 to each POI 501 within a POI cluster 810, then the refinement module 702 may determine an average proximity of the POI cluster 810 to the current location 802 based on the combination of distances of each POI 501 from the current location 802. In some examples, the distance/average proximity to user selected POIs define an average distance from the user location (e.g., the geolocation of the user 10, or geolocation of the center of the search area 800 if determined from the search query 212). A first POI cluster 810 having a smaller average proximity to a current location 802 than a second POI cluster receives a smaller score. In some examples, the proximity module 702 considers the popularity and quality of the POI 501 (e.g., included in the POI data 512 of each POI record). For example, if a POI 501 is restaurant, the refinement module 702 determined how popular the restaurant is and associates a score based on the restaurant popularity. Popularity of a POI 501 may be determined by considering if the POI 501 is trending on the internet, for example, if the restaurant is mentioned at a greater rate than others on social media or the internet. The refinement module 702 associates a higher score with a POI 501 that is trending more than another POI 501. Another parameter that the refinement module 702 may use is the cluster tightness, which refers to the distance of each POI 501 with respect to other POIs 501 within the cluster 810. The refinement module 702 gives a POI cluster 810 a higher score when the POIs 501 within the cluster 810 are closer to one another. Another POI parameter than the refinement module 702 may consider is the user's personal bias. For example, if the user 10 frequents a POI 501 (e.g., a restaurant) more often than others, that POI 501 might have a higher score than the other POIs 501 within the cluster 810. In some examples, the personal bias parameter gives a cluster 810 a higher score when the cluster 810 contains POIs 501 that the user 10 has ties to or frequently visits. For example, POIs 501 that the user 10 has been to, searched for, reviewed, etc. may be favored by the refinement module 702.

Additional parameters that the refinement module 702 may consider include cluster relevance. The refinement module 702 determines a cluster relevance based on the relevance of each POI 501 (e.g., POI name or ID 510) with the search query 212. Additional examples of features may include entity type, entity density, popularity density, result average density.

In some implementations, the refinement module 702 uses a machine learned scoring model in combination with one or more of the above parameters to determine a score associated with each POI record 500 or POI cluster 810. In other examples, the refinement module 702 uses one or more rules associated with the above parameters to determine a score for each POI record 500 associated with POIs 501 within a POI cluster 810, and then determine a score of the POI cluster 801 based on the individual scored of each POI record 500 of the POI cluster 810.

The refinement module 702 can select one or more POI clusters 810 based on the respective scores 227. For each selected POI cluster 810, the refinement module 702 generates the location-based refinements 220b. The refinement module 702 generates a display portion (e.g., search query link data 252) and a refinement query (e.g., refinement search query 221). The refinement module 702 generates the display portion 272 based on the name of the POI clusters 810. The refinement module 702 can construct the display portion using the processed search query 701 or the category of the cluster of POIs 501. For example, if the processed search query 701 includes the query term “coffee shops,” then the display portion 272 may be constructed using the query term “coffee shops.” The refinement module 702 can then amend the name of the POI clusters 810 to the display portion 272. Thus, if a first POI cluster 810 is labeled with the name “near work” and a second POI cluster 810 is labeled with the name “on the way home,” a first display portion of a first displayed location-based refinement 250 is “coffee shops near work” and a second display portion of a second displayed location-based refinement 250 is “coffee shops on the way home.”

The refinement module 702 generates the refined search query 221 corresponding to a query based on the shape that the refinement module 702 overlaid on the POI cluster 810. The refinement module 702 may use the geographic description of the shape (e.g., a geolocation and radius of a circle, a geolocation of a rectangle) and the category or processed search query 701 to generate the refined search query 221. The refinement module 702 may use a template to generate a URL or equivalent using the geographic description. The refinement module 702 combines the display portion 272 and the refined search query 221 to obtain the location-based refinement 220b. The location-based refinements 220b are output to the results processing module 706, which generates the search results 220 using the location-based refinements 220b.

The refinement module 702 determines a score of each POI cluster 810 within the search area 800 or within the search area 800 and adjacent to the search area 800 by determining a score of each POI 501 associated with a POI record 500 and then determining the score of the POI cluster 810. The refinement module 702 considers one or more parameters for determining the score of each POI 501 and subsequently each POI cluster 810. Additionally, each parameter may have a different weight than another parameter based on the importance or relevance of the parameter.

The set generation module 704 identifies a plurality of application state records 400 based on the received search query 212. In some examples, the set generation module 704 identifies the application state records 400 based on matches between terms of the search query 212 and terms in the application state records 400. For example, the set generation module 704 may identify the application state records 400 based on matches between tokens generated by the query analysis module 700 and words included in the application state records 400, such as words included in the application state IDs 410 and/or the application state information 420.

The consideration set 710 of application state records 400 may refer to the application state records 400 that are to be scored by the result processing module 706. The set generation module 704 may determine the geo-location of the user device 200 based on data included in the query wrapper 210. In additional examples, if the query analysis module 700 detects a query-specified location, the set generation module 704 uses the query-specified location as the search location. In some examples, the set generation module 704 uses the geo-location of the user device 200 as the search location (e.g., to filter application state records 400 based on location).

The result processing module 706 may score the application state records 400 in the consideration set 710 in order to generate a set of organic results 220a. The scores 226 associated with the application state records 400 may be referred to as “result scores.” The result processing module 706 may determine a result score 226 for each of the application state records 400 in the consideration set 710. The result scores 226 associated with an application state record 400 may indicate the relative rank of the application state record 400 (e.g., by the access mechanisms 202) among other application state records 400. For example, a larger result score 226 may indicate that an application state record 400 is more relevant to the received search query 212.

The result processing module 706 selects application access mechanisms 202 from the selected application state records 400 (e.g., the highest scoring function records). The result processing module 706 transmits the selected application access mechanisms 202 to the user device 200 that generated the search query 212. The result processing module 706 may also transmit the result scores 226 associated with the selected application access mechanisms 202. For example, an application access mechanism 202 may be associated with the result score 226 of the application state record 400 from which the application access mechanism 202 was selected.

The information conveyed by the organic results 220a may depend on how the result scores 226 are calculated by the result processing module 706. For example, the result scores 226 may indicate the relevance of an application function or application state to the search query 212, the popularity of an application function or state, or other properties of the application function or state, depending on what parameters the result processing module 706 uses to score the application state records 400.

The result processing module 706 may generate result scores 226 for application state records 400 in a variety of different ways. In some implementations, the result processing module 706 generates a result score 226 for an application state record 400 based on one or more scoring features. The scoring features may be associated with the application state record 400 and/or the search query 212. A function record scoring feature (hereinafter “record scoring feature”) may be based on any data associated with an application state record 400. For example, record scoring features may be based on any data included in the application state information 420 of the application state record 400. Example record scoring features may be based on metrics associated with a person, place, or thing described in the application state record 400. Example metrics may include the popularity of a place described in the application state record 400 and/or ratings (e.g., user ratings) of the place described in the application state record 400. For example, if the application state record 400 describes a song, a metric may be based on the popularity of the song described in the application state record 400 and/or ratings (e.g., user ratings) of the song described in the application state record 400. The record scoring features may also be based on measurements associated with the application state record 400, such as how often the application state record 400 is retrieved during a search and how often access mechanisms 202 of the application state record 400 are selected by the user 10. Record scoring features may also be based on whether the application state record 400 includes an application access mechanism 202 that leads to a default state or a deeper native application state.

A query scoring feature may include any data associated with the search query 212. For example, query scoring features may include, but are not limited to, a number of words in the search query 212, the popularity of the search query 212, and the expected frequency of the words in the search query 212. A record-query scoring feature may include any data generated based on data associated with both the application state record 400 and the search query 212 that resulted in identification of the application state record 400 by the set generation module 704. For example, record-query scoring features may include, but are not limited to, parameters that indicate how well the terms of the search query 212 match the terms of the application state information 420 of the identified application state record 400. The result processing module 706 may generate a result score 226 for an application state record 400 based on at least one of the record scoring features, the query scoring features, and the record-query scoring features.

The result processing module 706 may determine a result score 226 for an application state record 400 based on one or more of the scoring features listed herein and/or additional scoring features not explicitly listed. In some examples, the result processing module 706 includes one or more machine learned models (e.g., a supervised learning model) configured to receive one or more scoring features. The one or more machine learned models may generate result scores 226 based on at least one of the record scoring features, the query scoring features, and the record-query scoring features. For example, the result processing module 706 may pair the search query 212 with each application state record 400 and calculate a vector of features for each (query, record) pair. The vector of features may include one or more record scoring features, one or more query scoring features, and one or more record-query scoring features. The result processing module 706 may then input the vector of features into a machine-learned regression model to calculate a result score for the application state record 400. In some examples, the machine-learned regression model includes a set of decision trees (e.g., gradient boosted decision trees). In another example, the machine-learned regression model may include a logistic probability formula. In some examples, the machine learned task is framed as a semi-supervised learning task, where a minority of the training data is labeled with human curated scores and the rest are used without human labels.

The result scores 226 associated with the application state records 400 (e.g., access mechanisms 202) may be used in a variety of different ways. The result processing module 706 and/or the user device 200 may rank the access mechanisms 202 based on the result scores 226 associated with the access mechanisms 202. In these examples, a larger result score may indicate that the access mechanism 202 (e.g., the function or application state) is more relevant to the user 10 than an access mechanism 202 having a smaller result score. In examples where the user device 200 displays the organic results 220a as a list, the user device 200 may display the links 270, 280 for access mechanisms 202 having larger result scores 226 nearer to the top of the results list (e.g., near to the top of the screen). In these examples, the user device 200 may display the links 260, 270 for access mechanisms 202 having lower result scores 226 farther down the list (e.g., off screen). In some examples, as illustrated in FIG. 2, the user device 200 groups together the links 260, 270 associated with the same native application 204a.

The result processing module 706 determines which organic results 220a and location-based refinements 220b to send to the user device 200 as the combined search results 220. As described with respect to FIGS. 2A-2C, the user device 200 displays the organic search results as displayed user-selectable links 260, 270 and the refined search query 220b as a displayed location-based refinement 250 with a corresponding user-selectable link 260, 270.

When the user 10 selects a displayed location-based refinement 250 (e.g., via the link) from the result list 251, the search system 300 processes the refined search query 221 associated with the displayed location-based refinement 250 in the same way as a normal search query 212. The refined search query 221 may include a flag indicating that the received query is a refined search query 221. The flag may instruct the query analysis module 700 of the search module 360 to use the geographic description of the shape in the search query as the search location. Additionally, the refined search query 221 may contain other constraints and/or preference information, such as favoring one particular category of results. The search module 360 may process the refined search query 221 in the same manner as the original search query 212.

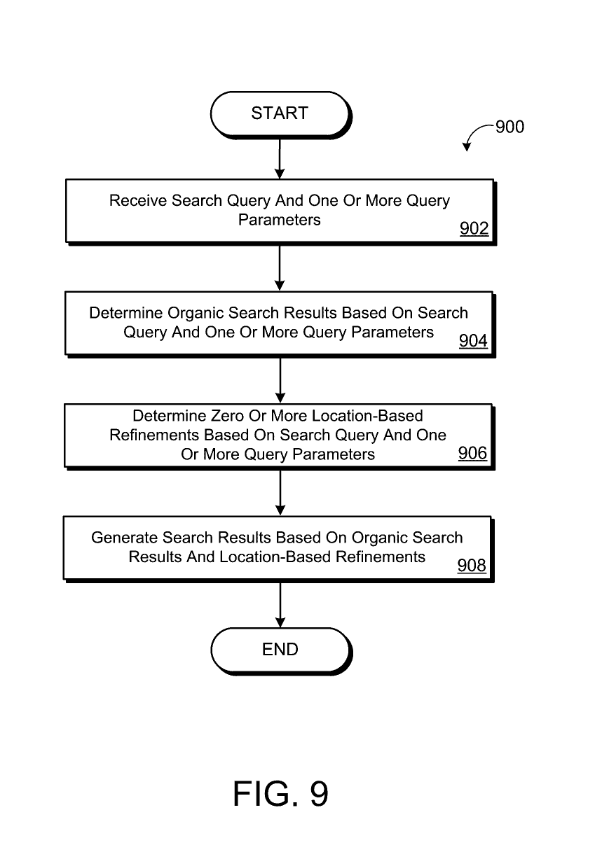

FIG. 9 illustrates an example set of operations for a method 900 of generating search results 220 that include organic results 220a and location-based refinements 220b. The method 900 is described with reference to the search system 300 described in the above figures. The method 900, may however, be executed by any other suitable component.

At block 902, the search module 360 receives a search query 212 and one or more parameters, such as device location data 206 (e.g., geo-location) that indicates: the location of the user device 200, such as latitude and longitude coordinates; an IP address 209, which the search module 310 may use to determine the location of the user device 200; platform data 208 (e.g., version of the operating system 224, device type, and web-browser version); an identity of the user 10 of the user device 200 (e.g., a username), partner specific data; and/or other data. In some examples, the method 900 receives a query wrapper 210 that includes the search query 212 and the parameters.

At block 904, the search module 360 includes determining organic search results 220a based on the search query 212 and one or more parameters 206, 208, 209. The search system 300 executes a search of its application data store 330 to find one or more application state records 400 stored in the application data store 330 that satisfy the search query 212. In some implementations, the set generation module 704 identifies a plurality of application state records 400 based on the received search query 212. In some examples, the set generation module 704 identifies the application state records 400 based on matches between terms of the search query 212 and terms in the application state records 400. At block 906, the refinement module 702 outputs location-based refinements 220b when available based on the received search query 212. The refinement module 702 is in communication with the POI data store 340. Therefore, the location-based refinements 220b are associated with a location that is within (or within and adjacent to) the location search area of the search query 212.

The result processing module 706 receives a consideration set 710 that includes the organic results 220a from the set generation module 704 and the location-based refinements 220b from the refinement module 702 and determines which organic results 220a and location-based refinements 220b to send to the user device 200 as the combined search results 220. At block 908, the result processing module 706 generates the search results 220 including the organic results 220a and the location-based refinements.

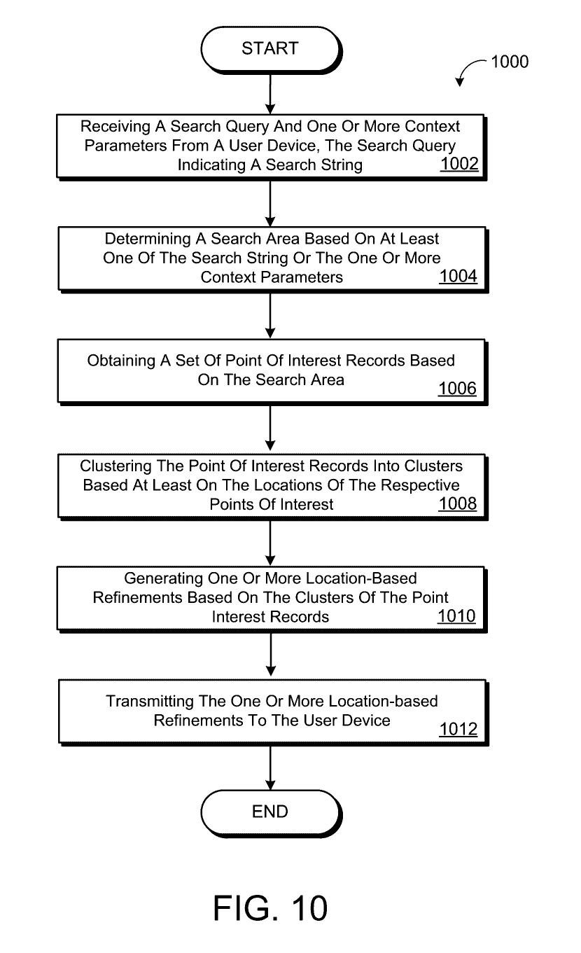

FIG. 10 illustrates an example set of operations for a method 1000 of generating location-based refinements 220b. The method 1100 is described with reference to the search system 300 described in FIG. 7. The method 1100, may however, be executed by any other suitable component.

At block 1002, the method 1000 includes receiving at a data processing device (e.g., the search system 300 or search module 360) a search query 212 and one or more context parameters 206, 208, 209. In some examples, the context parameters include one or more of a geo-location data 206, IP address 209, or a location associated with the search query 212. The search query 212 and the context parameters 206, 208, 209 may be received as a query wrapper 210. The search query 212 indicates a search string (e.g., entered by a user 10 via a GUI 218 of a user device 200).

At block 1004, the method 1000 includes determining a search area 800 based on at least one of the search string of the search query 212 or the one or more context parameters 206, 208, 209. For example, if the search query 212 has a search string that includes “late night diners in Detroit,” then the search system 300 determines that the search area 800 is Detroit. However, if the search query 212 has a search string that includes “late night diners,” then the search system 300 considers the context parameters (e.g., geo-location data 206, IP address 209) to determine the search area 800. In this case, the search area 800 is the location of the user device 200.

At block 1006, the method 1000 includes, obtaining a set of POI records 500 (see FIGS. 5A and 5B) based on the search area 800. Each POI record 500 identifies a POI 501, a location of the POI 530, and one or more features of the POI (e.g., POI ID 510, POI data 512, classification data 520).

At block 1008, the method 1000 includes clustering the POI records 500 into clusters 810 based at least on the location of the respective POIs (e.g., POI location 530). Referring back to FIG. 8, a search area 800 may include clusters 810 having a different number of POI records 500 or POIs 501. Additionally, the clusters 810 may be different in size.

At block 1010, the method 1000 includes generating one or more location-based refinements 220b based on the clusters 810 of the POI records 500. Each location-based refinement 220b is based on one of the clusters 810 of the POI records 500. Each location-based refinement 220b includes a display portion (i.e., the search query link data 252) and a refined search query 221. The display portion (i.e., the search query link data 252) indicates an entity 601 and a refined search area 222 (e.g., the area associated with the cluster 810) corresponding to one or more POIs 501 defined in the cluster 810. The refined search query 221 is constrained by the refined search area 222. The entity 601 may include a location, a business name, a business type, a product name, a product type, a service provider name, a service type, or a destination.

At block 1012, the method 1000 includes transmitting the one or more location-based refinements 220b to the user device 200. The user device 200 receives the one or more location-based refinements 220b and displays them on the GUI 218 of the user device 200.

In some implementations, the method 1000 includes receiving one of the refined search queries 221 from the user device 200 in response to a user selection of a respective location-based refinement 220b. When the user selection is received, the method 1000 includes generating refined search results 240 that are based on the received refined search query 221 and the refined search area 222. The method 1000 also includes transmitting the refined search results 240 to the user device 200.

Each refined search result 240 may include a header 260 for an application executable by the user device 200, and one or more application access mechanisms 202 associated with the application and the search area 800. Each application access mechanism 202 has a reference to the application and indicates a performable operation for the application. The performable operation associated with the search area 800 or the refined search area 222.

In some examples, determining the search area 800 includes parsing the search string of the search query 212 to determine whether the search string explicitly defines a known location. When the search string includes a name of a known location, the method 1000 includes setting the search area 800 based on the known location. For example, if the search query 212 has a search string that includes “late night diners in New York,” then the search system 300 determines that the search area 800 is New York. When the search string fails to include the known location or the method 1000 fails to recognize an included known location (NYC, The Big Apple vs. New York City), the method 1000 includes determining a current location of the user device based on the one or more context parameters (e.g., geo-location data 206, IP address 209), and setting the search area 800 based on the current location of the user device. For example, if the search query 212 has a search string that includes “late night diners,” then the search system 300 considers the context parameters (e.g., geo-location data 206, IP address 209) to determine the search area 800. In this case, the search area 800 is the location of the user device 200. In some implementations, setting the search area 800 based on the known location includes identifying a geographic coordinate representing the known location, and determining a geographic perimeter about the known location. In other implementations, setting the search area 800 based on the current location of the user device 100 includes identifying a geographic coordinate representing the current location, and determining a geographic perimeter about the geographic coordinate.

Generating the one or more location-based refinements may include, for each cluster, determining a representative POI 501 of the cluster 801, scoring each cluster 810 based on one or more features of the cluster 810 and one or more features of the representative POI 501, and selecting one or more of the clusters 810 based on the scores thereof. Additionally, for each selected cluster 810, the method 1000 includes determining the entity 601 to use in the display portion based on the POI records 500 of the selected cluster 810. Also, for each cluster 810, the method 1000 includes determining the refined search area 222 based on the locations (e.g., POI location 530) defined in the POI records 500 of the selected cluster 810. The refined search area 222 contains each of the locations (e.g., POI location 530). The method 1000 also includes determining the refined search query 221 based on the entity 601 and the search area 800. In some implementation, the entity 601 that the search system 300 uses in the display portion is based on classification data 520 of the POI records 500 contained in the selected cluster 800. The classification data 520 of each POI record 500 defines one or more categories (e.g., categories 520a and/or subcategories 520b) of the POI 501 defined in the POI record 500. In some example, the refined search area 222 indicated in the display portion is based on a name of the representative POI. The representative POI of a particular cluster 810 may be one of a generally known POI, a user-specific POI, or an arbitrary POI.

In some implementations, determining the representative point of the cluster 810 includes determining whether the cluster 810 includes a user-specific POI related specifically to a user 10 of the user device 200. When the cluster 810 includes the user-specific POI or a generally known POI, the method 1000 includes setting the representative POI to the user specific POI. When the cluster 810 does not include the user-specific POI, the method 1000 includes determining whether the cluster 810 includes a generally known POI having at least a threshold popularity amongst a general population. In addition, when the cluster 810 includes the generally known POI, the method 1000 includes setting the representative POI to the generally known POI. When the cluster 810 does not include the user-specific POI, the method includes selecting an arbitrary POI within the cluster 810 and setting the representative POI to the arbitrary POI.

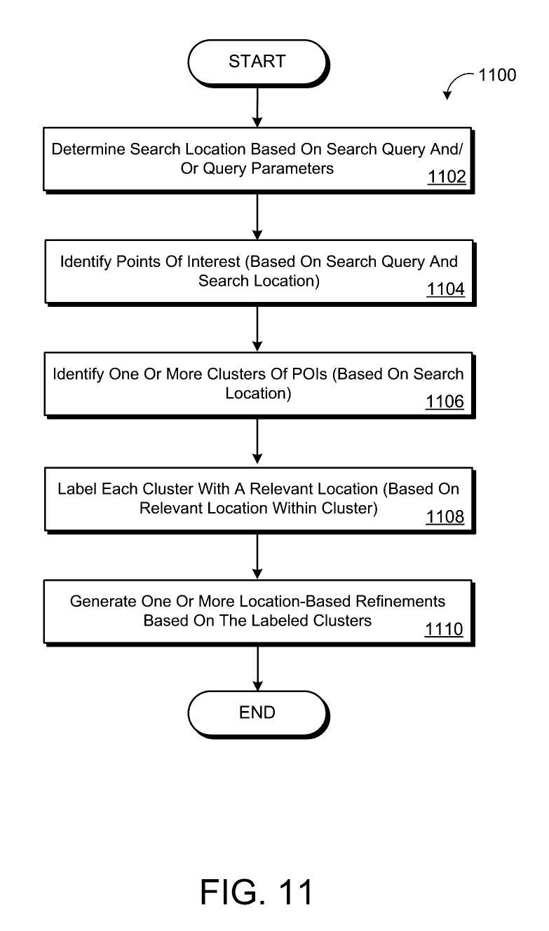

FIG. 11 illustrates an example set of operations for a method 1100 of generating location-based refinements 220b. The method 1100 is described with reference to the search system 300 described in FIG. 7. The method 1100, may however, be executed by any other suitable component.

At block 1102, the search module 360 receives a query wrapper 210 from the user device 200. The query analysis module 700 receives the query wrapper 210 that includes the search query 212. In some examples, the query analysis module 700 performs various analysis operations on the received search query 212 and/or query wrapper 210 to determine the search location associated with the search query 212. The query analysis module 700, in some examples, may parse and analyze the search query 212 to determine an associated search area 800 of the query 212. The search location may define a geographic area (e.g., a city, a street within a city, a street intersection, or any other geographical identifier) that relates to the search query 212. The search system 300 narrows its search to the search area 800 determined. The query analysis module 700 outputs the search area 800 and the processed search query 701 to the set generation module 704 and the refinement module 702.

At block 1104, the refinement module 702 identifies one or more POIs 501, each associated with a POI record 500 stored in the POI data store 340 in communication with the search module 360. The refinement module 702 identifies one or more POIs 501 based on the search area 800. For example, each POI record 500 includes geographic data 530 indicative of the location of the POI 501. Therefore, when selecting the POIs 501, the refinement module 702 verifies that the geographic data 530 associated with each POI 501 is within the search area 800.

At block 1106, the refinement module 702 clusters the identified POIs 501 located within the search area 800 based on one or more features. The features on which the POIs are clustered may include the geographic data 530 of the POIs 501 and the category 520a of the POIs 501. The POIs 501 may be clustered according to subcategories 502b as well. In some examples, the POI clusters 810 are based on an entity 601.

At block 1108, the refinement module 702 labels or names each POI cluster 810 based on a relevant POI 501a. A relevant POI 501a may be the name of a generally-known POI, a user-specific POI, or an arbitrary POI. A generally known POI 501a may be a known landmark or location (e.g., Union Square, Metro Airport, etc.) that resides in the shape surrounding the POI clusters 810. These types of POIs 501 may be obtained from the POI database (maybe the most popular POIs 501). The user-specific POI 501a is a POI 501a that is relevant to the user 10. Examples of user-specific POIs 501a are “near me,” work, home, friends and families houses, on my current route, on my drive home, etc. The user-specific POIs may be identified in various manners. At block 1110, the refinement module 702 generates one or more location-based refinements 220b based on the search query 212 and the label or name associated with the POI cluster 810.

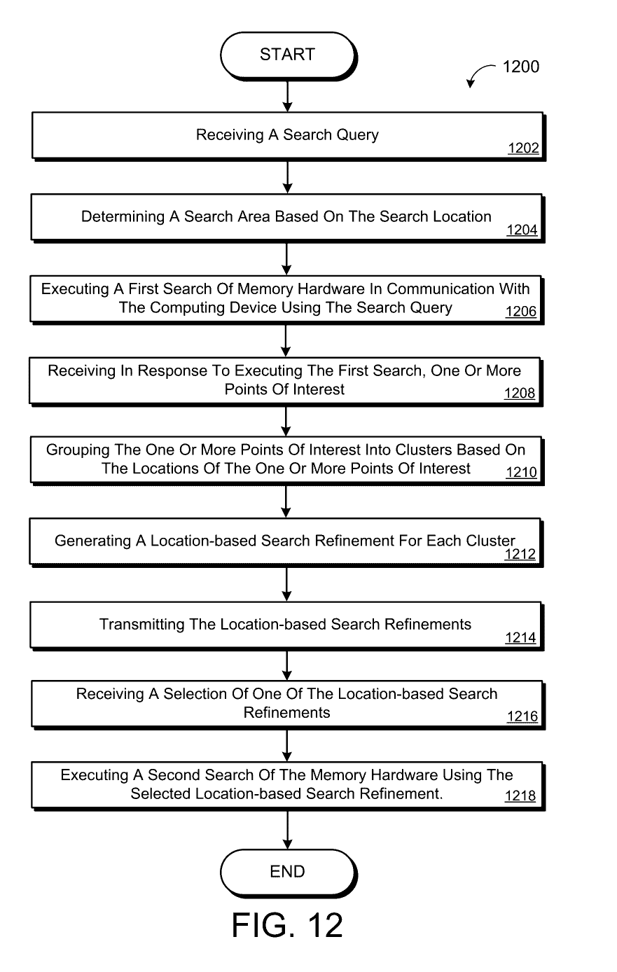

FIG. 12 illustrates another example set of operations for a method 1200 of generating search results 220 that include organic results 220a and location-based refinements 220b. The method 1200 is described with reference to the search system 300 described in FIGS. 1A-3. The method 1200, may however, be executed by any other suitable component.

At block 1202, the method 1200 includes receiving a search query 212 or a query wrapper 210 from the user device 200. The search query 212 or the query wrapper 210 includes a search string 212 and a search location (e.g., geo-location data 206, IP address 209, or a location associated with the search query 212). At block 1104, the method 1200 includes determining a search area 800 based on the search location 206, 209. At block 1206, the method 1200 includes executing a first search of memory hardware 304 in communication with the computing device 302 using the query wrapper 210. At block 1206, the method 1200 includes receiving in response to executing the first search, points of interest 501. Each POI 501 is associated with a location within the search area 800 (or within and adjacent to the search area 800). At block 1210, the method 1200 includes grouping the points of interest 501 into clusters 810 based on the locations of the points of interest 501. At block 1202, the method 1200 includes generating a location-based refinement 220b for each cluster 810, where each location-based refinement 220b (or the refined search query 221) including at least a portion of the search string 212. At block 1214, the method 1200 includes transmitting to the user device 200, the location-based refinements 220b. At block 1216, the method 1200 further includes receiving from the user device 200, a selection of one of the location-based refinements 220b and at block 1218 executing a second search of the memory hardware 304 using the selected location-based refinement 220b.

In some implementations, the search location includes a location of the user device 200. Determining the search area 800 may include determining a geographic perimeter about the search location. Additionally or alternatively, the geographic perimeter may be located at least a threshold distance from the search location when a number of the points of interest 501 located within the geographic perimeter is less than a POI threshold, and the geographic perimeter is located less than the threshold distance from the search location when the number of the points of interest located within the geographic perimeter is greater than or equal to the POI threshold.

In some examples, grouping the points of interest into clusters 810 includes identifying points of interest 501 located within a threshold distance from each other and grouping the points of interest located within the threshold distance from each other into a cluster. Grouping the points of interest into clusters may further include associating categories with the POIs, identifying points of interest having the same category and for each category, grouping the points of interest having the same category into a cluster. The method 1200 may further include receiving a user selection of one or more points of interests 501. Grouping the points of interest may include identifying one or more points of interest located within a threshold distance from the one or more user selected points of interest. For each user selected points of interest, the method 1200 includes grouping the points of interest located within the threshold distance from the user selected points of interest into a cluster.

In some implementations, the method 1200 includes receiving in response to executing the second search, one or more refined search results 240. Each refined search result 240 includes a header 260 for an application executable on the user device 200 and one or more application access mechanism 202 associated with the application and the search location. Each application access mechanism 202 may have a reference to the application 204 and indicate a performable operation for the application 204. The method 1200 may further include associating a score 227 with each cluster 810 based on a geographic relevancy of the cluster 810 with a location of the user device 200. The method 1200 may further include transmitting the location-based refinements 220b of the clusters 810 having a score 227 satisfying a score criterion.

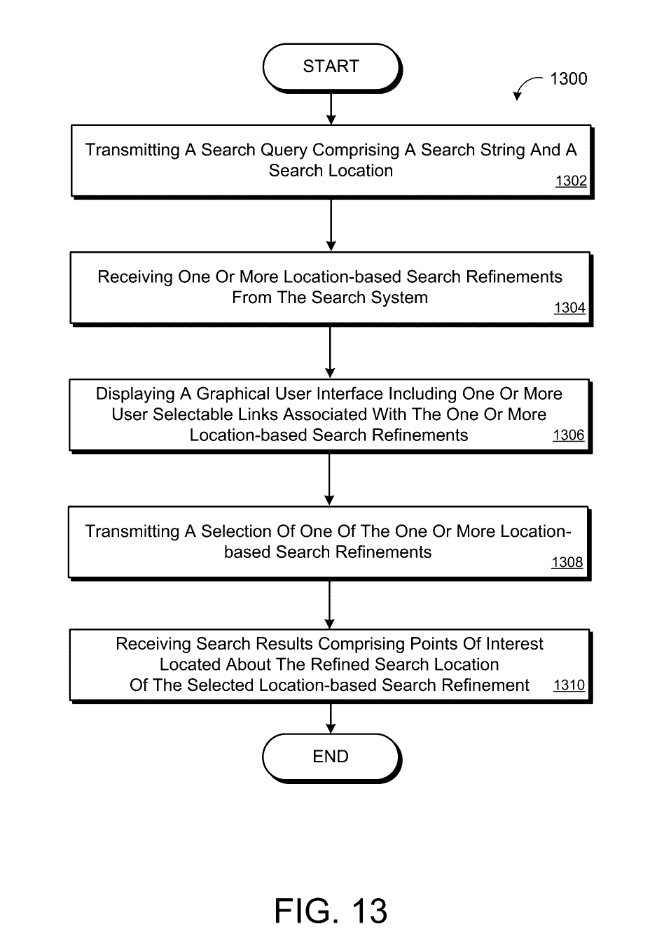

FIG. 13 illustrates an example set of operations for a method 1300 of receiving search results 220 that include organic results 220a and location-based refinements 220b. The method 1300 is described with reference to the search system 300 described in FIGS. 1A-3. The method 1300, may however, be executed by any other suitable component.

At block 1302, the method 1300 includes transmitting, from a user device 200 to a search system 300 in communication with the user device 200, a query wrapper 210 that includes a search string 212 and a search location (e.g., geo-location data 206, IP address 209, or a location associated with the search query 212). At block 1304, the method 1300 includes receiving one or more location-based refinements 220b from the search system 300. At block 1306, the method includes displaying, on a display 201 in communication with the user device 200, a graphical user interface 218 including one or more user selectable links 250 associated with the one or more location-based refinements 220b. Each location-based refinement 220b includes at least a portion of the search string 212 and a refined search location. At block 1308, the method 1300 includes transmitting a selection of one of the one or more location-based refinements 220b. And at block 1310, the method includes receiving refined search results 240 including points of interest 501 located about the refined search location of the selected location-based refinement 220b.

In some examples, the search location includes a location of the user device 200. Each refined search location may be located within a search area 800 having a geographic perimeter about the search location. Additionally or alternatively, the geographic perimeter may be located at least a threshold distance from the search location when a number of the points of interest located within the geographic perimeter is less than a POI threshold, and the geographic perimeter is located less than the threshold distance from the search location when the number of the points of interest located within the geographic perimeter is greater than or equal to the POI threshold. Each POI 501 may be located a threshold distance from the refined search location and each POI may be located a threshold distance from another POI 501. The points of interest 501 may all have a common associated category or entity 600.

In some examples, the method 1300 further includes displaying a header 260 for an application 204 executable on the user device 200 and one or more user selectable header links 270 grouped with the header 260. Each user selectable header link 270 may be associated with a POI 501, where selection of the user header link 270 causes the user device 200 to display information associated with the corresponding POI.

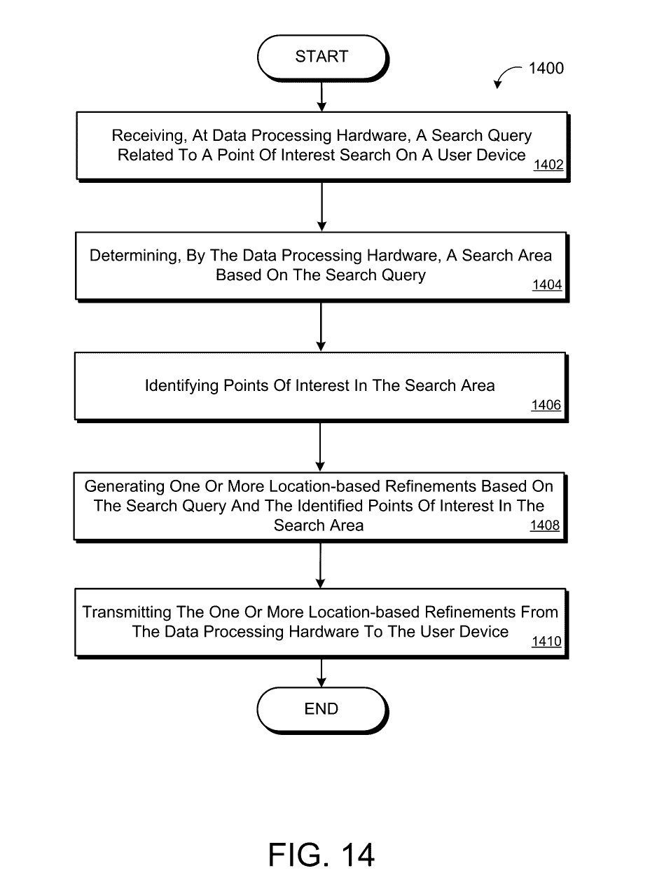

FIG. 14 illustrates an example set of operations of a method 1400 method for generating and transmitting location-based refinements 250 based on a search query 212 and identified points of interest in a search area. The method 1400 is described with reference to the search system 300 described in FIGS. 1A-3. The method 1400, may however, be executed by any other suitable component.

FIG. 14 illustrates an example set of operations of a method 1400 1400 for generating and transmitting location-based refinements 250 (e.g., the displayed location-based refinements 250) based on a search query 212 and identified POIs 501 in a search area 800. The method 1400 is described with reference to the search system 300 described in FIGS. 1A-3. The method 1400, may however, be executed by any other suitable component.

At block 1402, the method 1400 includes receiving, at data processing hardware (e.g., the search system 300 or search module 360), a search query 212 related to a POI 501 search on a user device 200. At block 1404, the method 1400 includes determining, by the data processing hardware, a search area 800 based on the search query 212. At block 1406, the method 1400 further includes identifying, by the data processing hardware, POIs 501 in the search area 800. At block 1408, the method 1400 includes generating one or more location-based refinements 250 based on the search query 212 and the identified POIs 501 in the search area 800. Each location-based refinement 250 is a modification of the search query 212 that includes a geographical location constraint 222 narrowing the search area 800. At block 1410, the method 1400 also includes transmitting the one or more location-based refinements 250 from the data processing hardware to the user device 200.

In some implementations, the method 1400 includes determining the search area 800 based on one or more context parameters 206, 208, 209 from the user device 200. The search query 212 may include a search string (e.g., entered by a user 10 via a GUI 218 of the user device 200). Determining the search area 800 may include parsing the search string to determine whether the search string explicitly defines a known location 501a (e.g., a generally known POI 501a which may be a known landmark or location). When the search string includes a name of a known location 501a, the method 1400 includes setting the search area 800 based on the known location 501a. When the search string fails to include the known location 501a, the method 1400 includes determining a current location 802 of the user device 200 based on the one or more context parameters 206, 208, 209 and setting the search area 800 based on the current location 802 of the user device 200. Setting the search area 800 based on the known location 501a may include identifying a geographic coordinate representing the known location 501a and determining a geographic perimeter about the known location 501a. Setting the search area 800 based on the current location 802 of the user device 200 may further include identifying a geographic coordinate representing the current location 802 and determining a geographic perimeter about the geographic coordinate.

In some examples, identifying the POIs 501 in the search area 800 may include obtaining, by the data processing hardware, a set of POI records 500 based on the search area 800. Each POI record 500 may identify a POI 501, a location 530 of the POI, and one or more features of the POI (e.g., POI data 512, classification/category data 520a, and sub-category data 520b). The method 1400 may also include clustering, by the data processing hardware, the POI records 500 into clusters 810 based at least on the locations of the respective POIs 501 and generating, by the data processing hardware, the one or more location-based refinements 250 based on the clusters 810 of the POI records 500. Each location-based refinements 250 may be based on one of the clusters 810 of the POI records 500 and include: i) a display portion indicating an entity 600 and a refined search area 222 corresponding to one or more POIs 501 defined in the cluster 810; and ii) a refined search query 212 constrained by the refined search area 222. The one or more features of each point of interest record may include classification data indicating one or more categories of the point of interest. The POI records 500 may be clustered based on the respective locations identified in the POI records 500 and the classification data defined in the POI records 500.

In some examples, the method 1400 includes receiving, at the data processing hardware, one of the refined search queries 221 from the user device 200 in response to a user selection of a respective location-based refinement 220b. The method 1400 may also include generating, by the data processing hardware, refined search results 240 based on the received refined search query 212 and the refined search area 222, and transmitting, by the data processing hardware, the search results 240 to the user device 200. Each search result 240 may include a header for an application executable by the user device 200 and one or more application access mechanisms 202 associated with the application and the search area 800. Each application access mechanism 202 may have a reference to the application and indicate a performable operation for the application, the performable operation associated with the search area 800.

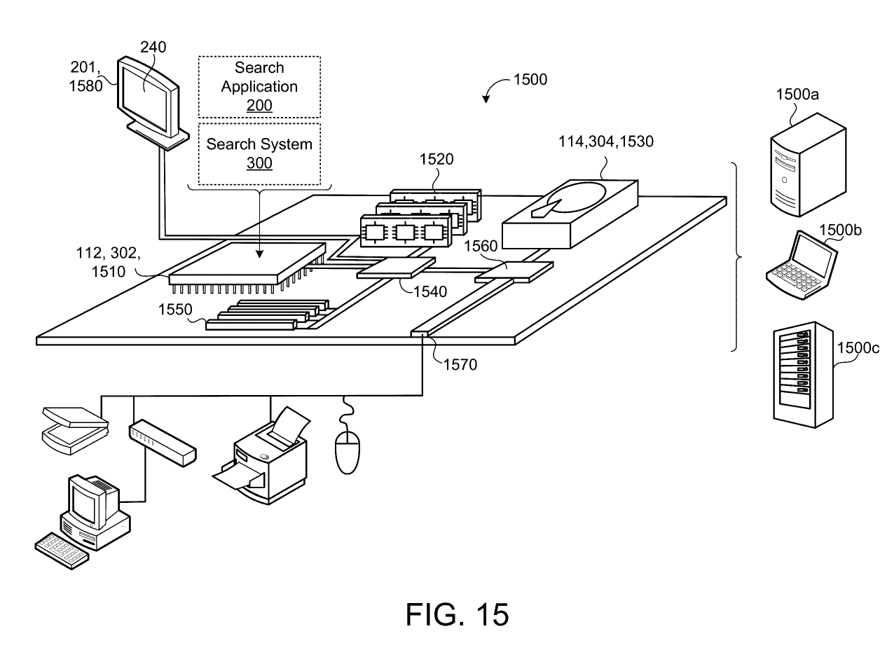

FIG. 15 is schematic view of an example computing device 1500 that may be used to implement the systems and method 1200s described in this document. The computing device 1500 is intended to represent various forms of digital computers, such as laptops, desktops, workstations, personal digital assistants, servers, blade servers, main frames, and other appropriate computers. The components shown here, their connections and relationships, and their functions, are meant to be exemplary only, and are not meant to limit implementations of the inventions described and/or claimed in this document.

The computing device 1500 includes a processor 1510, memory 1520, a storage device 1530, a high-speed interface/controller 1540 connecting to the memory 1520 and high-speed expansion ports 1550, and a low speed interface/controller 1560 connecting to low speed bus 1570 and storage device 1530. Each of the components 1510, 1520, 1530, 1540, 1550, and 1560, are interconnected using various busses, and may be mounted on a common motherboard or in other manners as appropriate. The processor 1510 can process instructions for execution within the computing device 1500, including instructions stored in the memory 1520 or on the storage device 1530 to display graphical information for a graphical user interface (GUI) on an external input/output device, such as display 1580 coupled to high speed interface 1540. In other implementations, multiple processors and/or multiple buses may be used, as appropriate, along with multiple memories and types of memory. Also, multiple computing devices 1500 may be connected, with each device providing portions of the necessary operations (e.g., as a server bank, a group of blade servers, or a multi-processor system).

The memory 1520 stores information non-transitorily within the computing device 1500. The memory 1520 may be a computer-readable medium, a volatile memory unit(s), or non-volatile memory unit(s). The non-transitory memory 1520 may be physical devices used to store programs (e.g., sequences of instructions) or data (e.g., program state information) on a temporary or permanent basis for use by the computing device 1500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 1530 is capable of providing mass storage for the computing device 1500. In some implementations, the storage device 1530 is a computer-readable medium. In various different implementations, the storage device 1530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more method 1200s, such as those described above. The information carrier is a computer- or machine-readable medium, such as the memory 1520, the storage device 1530, or memory on processor 1510.

The high speed controller 1540 manages bandwidth-intensive operations for the computing device 1500, while the low speed controller 1560 manages lower bandwidth-intensive operations. Such allocation of duties is exemplary only. In some implementations, the high-speed controller 1540 is coupled to the memory 1520, the display 1580 (e.g., through a graphics processor or accelerator), and to the high-speed expansion ports 1550, which may accept various expansion cards (not shown). In some implementations, the low-speed controller 1560 is coupled to the storage device 1530 and low-speed expansion port 1570. The low-speed expansion port 1570, which may include various communication ports (e.g., USB, Bluetooth, Ethernet, wireless Ethernet), may be coupled to one or more input/output devices, such as a keyboard, a pointing device, a scanner, or a networking device, such as a switch or router, e.g., through a network adapter.

The computing device 1500 may be implemented in a number of different forms, as shown in the figure. For example, it may be implemented as a standard server 1500a or multiple times in a group of such servers 1500a, as a laptop computer 1500b, or as part of a rack server system 1500c.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with the user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with the user by sending documents to and receiving documents from a device that is used by the user; for example, by sending web pages to a web browser on the user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which the user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from the user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method comprising:
receiving, at data processing hardware, a search query related to a point of interest search on a user device;
determining, by the data processing hardware, a search area based on the search query;
identifying, by the data processing hardware, points of interest in the search area;
generating, by the data processing hardware, one or more location-based refinements based on the search query and the identified points of interest in the search area, each location-based refinement being a modification of the search query that includes a geographical location constraint narrowing the search area; and
transmitting the one or more location-based refinements from the data processing hardware to the user device.

2. The method of claim 1, further comprising determining the search area based on one or more context parameters from the user device.

3. The method of claim 1, wherein search query comprises a search string, and determining the search area comprises:
parsing the search string to determine whether the search string explicitly defines a known location;
when the search string includes a name of a known location, setting the search area based on the known location; and
when the search string fails to include the known location:
determining a current location of the user device based on the one or more context parameters; and
setting the search area based on the current location of the user device.

4. The method of claim 3, wherein setting the search area based on the known location comprises:
identifying a geographic coordinate representing the known location; and
determining a geographic perimeter about the known location.

5. The method of claim 3, wherein setting the search area based on the current location of the user device comprises:
identifying a geographic coordinate representing the current location; and
determining a geographic perimeter about the geographic coordinate.

6. The method of claim 1, wherein identifying the points of interest in the search area comprises obtaining, by the data processing hardware, a set of point of interest records based on the search area, each point of interest record identifying a point of interest, a location of the point of interest, and one or more features of the point of interest.

7. The method of claim 6, further comprising:
clustering, by the data processing hardware, the point of interest records into clusters based at least on the locations of the respective points of interest; and
generating, by the data processing hardware, the one or more location-based refinements based on the clusters of the of point of interest records, each location-based refinement being based on one of the clusters of the of point of interest records and including i) a display portion indicating an entity and a refined search area corresponding to one or more points of interest defined in the cluster, and ii) a refined search query constrained by the refined search area.

8. The method of claim 7, wherein the one or more features of each point of interest record include classification data indicating one or more categories of the point of interest, and the point of interest records are clustered based on the respective locations identified in the point of interest records and the classification data defined in the point of interest records.

9. The method of claim 1, further comprising:
receiving, at the data processing hardware, one of the refined search queries from the user device in response to a user selection of a respective location-based refinement;
generating, by the data processing hardware, search results based on the received refined search query and the refined search area; and
transmitting, by the data processing hardware, the search results to the user device.

10. The method of claim 9, wherein each search result comprises:
a header for an application executable by the user device; and
one or more application access mechanisms associated with the application and the search area, each application access mechanism having a reference to the application and indicating a performable operation for the application, the performable operation associated with the search area.

11. A method comprising:
receiving, at data processing hardware, a search query and one or more context parameters from a user device, the search query indicating a search string;
determining, by the data processing hardware, a search area based on at least one of the search string or the one or more context parameters;
obtaining, by the data processing hardware, a set of point of interest records based on the search area, each point of interest record identifying a point of interest, a location of the point of interest, and one or more features of the point of interest;
clustering, by the data processing hardware, the point of interest records into clusters based at least on the locations of the respective points of interest;
generating, using the data processing hardware, one or more location-based refinements based on the clusters of the point of interest records, each location-based refinement being based on one of the clusters of the of point of interest records and including i) a display portion indicating an entity and a refined search area corresponding to one or more points of interest defined in the cluster, and ii) a refined search query constrained by the refined search area; and
transmitting, by the data processing hardware, the one or more location-based refinements to the user device.

12. The method of claim 11, further comprising:
receiving, at the data processing hardware, one of the refined search queries from the user device in response to a user selection of a respective location-based refinement;
generating, by the data processing hardware, search results based on the received refined search query and the refined search area; and
transmitting, by the data processing hardware, the search results to the user device.

13. The method of claim 12, wherein each search result comprises:
a header for an application executable by the user device; and
one or more application access mechanisms associated with the application and the search area, each application access mechanism having a reference to the application and indicating a performable operation for the application, the performable operation associated with the search area.

14. The method of claim 11, wherein determining the search area comprises:
parsing the search string to determine whether the search string explicitly defines a known location;
when the search string includes a name of a known location, setting the search area based on the known location; and
when the search string fails to include the known location:
determining a current location of the user device based on the one or more context parameters; and
setting the search area based on the current location of the user device.

15. The method of claim 14, wherein setting the search area based on the known location comprises:
identifying a geographic coordinate representing the known location; and
determining a geographic perimeter about the known location.

16. The method of claim 14, wherein setting the search area based on the current location of the user device comprises:
identifying a geographic coordinate representing the current location; and
determining a geographic perimeter about the geographic coordinate.

17. The method of claim 11, wherein the one or more features of each point of interest record include classification data indicating one or more categories of the point of interest.

18. The method of claim 17, wherein the point of interest records are clustered based on the respective locations identified in the point of interest records and the classification data defined in the point of interest records.

19. The method of claim 11, wherein generating the one or more location-based refinements comprises:
for each cluster:
determining a representative point of interest of the cluster; and
scoring each cluster based on one or more features of the cluster and one or more features of the representative point of interest;
selecting one or more of the clusters based on the scores thereof;
for each selected cluster:
determining the entity to use in the display portion based on the point of interest records of the selected cluster; and
determining the refined search area based on the locations defined in the point of interest records of the selected cluster, the refined search area containing each of the locations; and
determining the refined search query based on the entity and the search area.

20. The method of claim 19, wherein the entity to use in the display portion is based on classification data of the point of interest records contained in the selected cluster, the classification data of each point of interest record defining one or more categories of the point of interest defined in the point of interest record.

21. The method of claim 20, wherein the refined search area indicated in the display portion is based on a name of the representative point of interest.

22. The method of claim 20, wherein the representative point of interest of a particular cluster is one of a generally known point of interest, a user-specific point of interest, or an arbitrary point of interest.

23. The method of claim 20, wherein determining the representative point of the cluster comprises:
determining whether the cluster includes a user-specific point of interest related specifically to a user of the user device;
when the cluster includes the user-specific point of interest or a generally known point of interest, setting the representative point of interest to the user specific point of interest;
when the cluster does not include the user-specific point of interest, determining whether the cluster includes a generally known point of interest having at least a threshold popularity amongst a general population;
when the cluster includes the generally known point of interest, setting the representative point of interest to the generally known point of interest; and
when the cluster does not include the user-specific point of interest:
selecting an arbitrary point of interest within the cluster; and
setting the representative point of interest to the arbitrary point of interest.

24. The method of claim 11, wherein each entity includes a location, a business name, a business type, a product name, a product type, a service provider name, a service type, or a destination.
